(19) United States
(12) Patent Application Publication
(10) Pub. No.: US 2014/0251649 A1
(43) Pub. Date: Sep. 11, 2014

(54) POWER TOOL ASSEMBLY, POWER TOOL, AND AUXILIARY HANDLE MEMBER

(71) Applicant: MAKITA CORPORATION, Anjo-shi (JP)

(72) Inventor: Tomoyuki KONDO, Anjo-shi (JP)

(73) Assignee: MAKITA CORPORATION, Anjo-shi (JP)

(21) Appl. No.: 13/793,436

(22) Filed: Mar. 11, 2013

(51) Int. Cl. B25F 5/02; B23Q 9/00

(52) U.S. Cl. CPC B25F 5/02; B23Q 9/00
USPC 173/170; 16/426

(57) ABSTRACT

A power tool assembly includes a power tool and an auxiliary handle member. An outer surface of a main body portion of the power tool includes first and second engagement structures. A fixing portion of the auxiliary handle member is fixed to the main body portion of the power tool with the fixing portion surrounding more than 180 degree of a circumference of the main body portion when viewed along a longitudinal axis of the main body portion. The fixing portion includes a first arm part with a first engagement section engaging with the first engagement structure and a second arm part with a second engagement section engaging with the second engagement structure. The first arm part and the second arm part are movable relative to each other to change a distance between the first engagement section and the second engagement section.

### BACKGROUND

1. Field of the Invention

The present invention generally relates to a power tool assembly. More specifically, the present invention relates to a power tool assembly in which an auxiliary handle member is removably coupled to a power tool.

2. Background Information

A conventional power tool, such as a driver drill, a hammer drill, an impact driver drill and the like, often includes a pistol-shaped housing having a grip portion, which is usually grasped by a user with one hand during operation. However, it is sometimes difficult to gain sufficient leverage to properly operate the power tool by holding the power tool with only one hand. Therefore, it is well known to provide an auxiliary handle or side handle on the power tool to enable the user to support the power tool with both hands during operation.

One example of a conventional side handle for a hand-held device includes a pair of semi-clamps coupled to a hand grip of the side handle. Each of the semi-clamps has an inner circumferential surface that matches a contour of an outer cylindrical circumferential surface of the housing of the hand-held device. As the hand grip is rotated, the semi-clamps move towards each other to tightly embrace a housing of the hand-held device. A further rotation of the hand grip causes substantial frictional forces to arise between the engageable surfaces of the semi-clamps and the housing, thereby preventing rotation of the side handle relative to the housing.

Another example of a conventional auxiliary handle for use with a power tool includes a pair of first and second clamps for engaging a housing of the power tool at first and second locations, respectively. The second clamp is movable independent from the first clamp toward or away from the first clamp to clamp or uncouple the auxiliary handle to or from the housing. The housing may be provided with a ring member including a plurality of apertures that receive a protrusion of each of the first and second clamps. Alternatively, the housing may be provided with a bulged part integrally formed in the first and second sides of the housing and the bulged part includes first and second apertures such that the first and second apertures open in directly opposed directions. The first clamp and the second clamp are arranged to together surround about a 90 degree portion of a chuck of the power tool.

### SUMMARY

In the first example of the conventional side handle as described above, it is necessary to provide a cylindrical part in the housing of the power tool in order for the semi-clamps to tightly embrace the housing. Therefore, it is required to provide a sufficient space in the front portion of the housing in order to form this cylindrical part at the front portion of the housing, which increases a longitudinal length of the housing. However, when the longitudinal length of the power tool is large, it becomes difficult to use the power tool in a small, confined space. Moreover, since the semi-clamps and the housing are held together only by the frictional force, when large torque is imparted on the power tool during operation, the auxiliary handle may accidentally slip off from the housing of the power tool or become misaligned with respect to the housing.

On the other hand, in the second example of the conventional auxiliary handle as described above, since the first clamp and the second clamp are arranged to together surround only about a 90 degree portion of a chuck of the power tool, attachment between the auxiliary handle and the power tool may be unreliable. In such a case too, when large torque is imparted on the power tool during operation, the auxiliary handle may accidentally slip off from the housing of the power tool. Moreover, when the apertures for engaging the first and second clamps are provided in a ring member, the ring member needs to be made of material having high rigidity and stiffness, such as metal, which would increase weight and manufacturing cost of the power tool. On the other hand, when the power tool is provided with a bulged part in which the apertures are formed, the bulged part bulges out from a main body of the power tool even though the bulged part has no use when the power tool is used without the auxiliary handle.

In view of the state of the known technology, a power tool assembly according to one aspect includes a power tool and an auxiliary handle member. The power tool includes a motor unit, a generally tubular main body portion, and a grip portion. The generally tubular main body portion accommodates the motor unit therein. An outer surface of the main body portion includes a first engagement structure disposed on a first side of the main body portion and a second engagement structure disposed on a second side of the main body portion. The grip portion extends from the main body portion. The auxiliary handle member includes an auxiliary grip portion, and a fixing portion. The fixing portion is fixed to the main body portion of the power tool for fixedly coupling the auxiliary grip portion to the main body portion with the fixing portion surrounding more than 180 degree of a circumference of the main body portion when viewed along a longitudinal axis of the main body portion. The fixing portion includes a first arm part with a first engagement section engaging with the first engagement structure and a second arm part with a second engagement section engaging with the second engagement structure. The first arm part and the second arm part are movable relative to each other to change a distance between the first engagement section and the second engagement section before the fixing portion is fixed to the main body portion of the power tool.

An auxiliary handle member according to another aspect is adapted to be coupled to a generally cylindrical main body portion of a power tool including a first engagement structure disposed on a first side of an outer surface of the main body portion and a second engagement structure disposed on a second side of the outer surface of the main body portion. The auxiliary handle member includes an auxiliary grip portion, and a fixing portion. The fixing portion is coupled to the grip portion, and configured and arranged to be fixedly coupled to the main body portion of the power tool with the fixing portion surrounding more than 180 degree of a circumference of the main body portion when viewed along a longitudinal axis of the main body portion. The fixing portion includes a first arm part with a first engagement section configured and arranged to engage with the first engagement structure, and a second arm part with a second engagement section configured and arranged to engage with the second engagement structure. The first arm part and the second arm part are movable relative to each other to change a distance between the first engagement section and the second engagement section.

A power tool according to another aspect includes a motor unit, a generally tubular main body portion, and a grip portion. The main body portion accommodates the motor unit therein. An outer surface of the main body portion includes a pair of auxiliary handle mounting structures extending along a longitudinal direction of the main body portion so as to slidably engage with an auxiliary handle member along the longitudinal direction. The grip portion extends from the main body portion.

A power tool assembly according to another aspect includes a power tool and an auxiliary handle member. The power tool includes a motor unit, and a resin housing member accommodating the motor unit therein. The auxiliary handle member includes a first arm part fixed to the resin housing member, and a second arm part fixed to the resin housing member.

A power tool assembly according to another aspect includes a power tool and an auxiliary handle member. The power tool includes a motor unit, and a housing member accommodating the motor unit therein. The auxiliary handle member includes a first arm part fixed to the housing member, and a second arm part fixed to the housing member. The first arm part is pivotable with respect to the second arm part.

A power tool assembly according to another aspect includes a power tool and an auxiliary handle member. The power tool includes a motor unit, and a housing accommodating the motor unit therein, the housing including at least three recesses. The auxiliary handle member is fixed to the housing of the power tool with the auxiliary handle member engaging with the recesses formed in the housing.

Other objects, features, aspects and advantages of the disclosed power tool with the power tool accessory member will become apparent to those skilled in the art from the following detailed description, which, taken in conjunction with the annexed drawings, discloses preferred embodiments of the power tool with the power tool accessory member.

### BRIEF DESCRIPTION OF THE DRAWINGS

Referring now to the attached drawings which form a part of this original disclosure:

FIG. 1 is a perspective view of a power tool assembly including a power tool and an auxiliary handle member according to a first embodiment;

FIG. 2 is a longitudinal cross sectional view of the power tool assembly illustrated in FIG. 1 as taken along a longitudinal direction of the power tool;

FIG. 3 is a partial transverse cross-sectional view of the power tool illustrated in FIGS. 1 and 2 as taken along a section line 3-3 in FIG. 2;

FIG. 4 is a perspective view of the power tool illustrated in FIGS. 1 to 3;

FIG. 5 a cross-sectional view of the auxiliary handle member illustrated in FIGS. 1 and 2 as taken along a longitudinal axis of a fastening rod part of the auxiliary handle member;

FIG. 6 is a transverse cross-sectional view of the power tool assembly illustrated in FIGS. 1 to 5 showing a state in which the auxiliary handle has not been fixed to the power tool;

FIG. 7 is a transverse cross-sectional view of the power tool assembly illustrated in FIGS. 1 to 5 showing a state in which the auxiliary handle is fixed to the power tool;

FIG. 8 is a perspective view of a power tool assembly including a power tool and an auxiliary handle member according to a second embodiment;

FIG. 9 is a cross-sectional view of the auxiliary handle member illustrated in FIG. 8 as taken along a longitudinal axis of a fastening rod part of the auxiliary handle member;

FIG. 10 is a transverse cross-sectional view of the power tool assembly illustrated in FIG. 8, showing a state in which the auxiliary handle has not been fixed to the power tool;

FIG. 11 is a transverse cross-sectional view of the power tool assembly illustrated in FIG. 8, showing a state in which the auxiliary handle is fixed to the power tool;

FIG. 12 is a perspective view of a power tool assembly including a power tool and an auxiliary handle member according to a third embodiment;

FIG. 13 is a cross-sectional view of the auxiliary handle member illustrated in FIG. 12 as taken along a longitudinal axis of a fastening rod part of the auxiliary handle member;

FIG. 14 is a transverse cross-sectional view of the power tool assembly illustrated in FIG. 12, showing a state in which the auxiliary handle has not been fixed to the power tool;

FIG. 15 is a transverse cross-sectional view of the power tool assembly illustrated in FIG. 12, showing a state in which the auxiliary handle is fixed to the power tool;

FIG. 16 is a perspective view of a power tool assembly including a power tool and an auxiliary handle member according to a fourth embodiment;

FIG. 17 is a longitudinal cross sectional view of the power tool assembly illustrated in FIG. 16 as taken along a longitudinal direction of the power tool;

FIG. 18 is a partial transverse cross-sectional view of the power tool assembly as taken along a section line 18-18 in FIG. 17;

FIG. 19 is a horizontal cross-sectional view of the power tool assembly as taken along a section line 19-19 in FIG. 17;

FIG. 20 is a partial transverse cross-sectional view of the power tool illustrated in FIGS. 16 to 19 as taken along the section line 18-18 in FIG. 17

FIG. 21 is a perspective view of the power tool illustrated in FIGS. 16 to 20;

FIG. 22 is a perspective view of the auxiliary handle member illustrated in FIGS. 16 to 19;

FIG. 23 is a side elevational view of the auxiliary handle member illustrated in FIG. 22;

FIG. 24 is a top plan view of the auxiliary handle member illustrated in FIGS. 22 and 23;

FIG. 25 is a front elevational view of the auxiliary handle member illustrated in FIGS. 22 to 24; and

FIG. 26 is a cross-sectional view of the auxiliary handle member illustrated in FIGS. 22 to 25 as taken along a section line 26-26 in FIG. 24.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

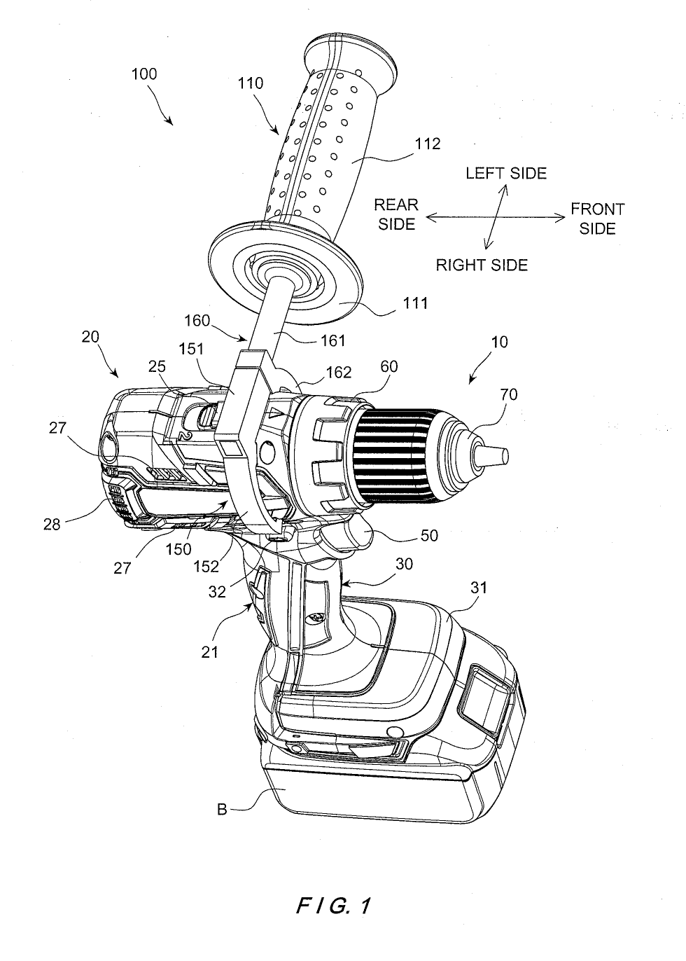

Referring initially to FIGS. 1 to 7, a power tool assembly including a power tool 10 and an auxiliary handle member 100 is illustrated in accordance with a first embodiment. The auxiliary handle member 100 is selectively coupled with the power tool 10 to provide a secondary grip position for a user to support the power tool 10 with both hands during operation.

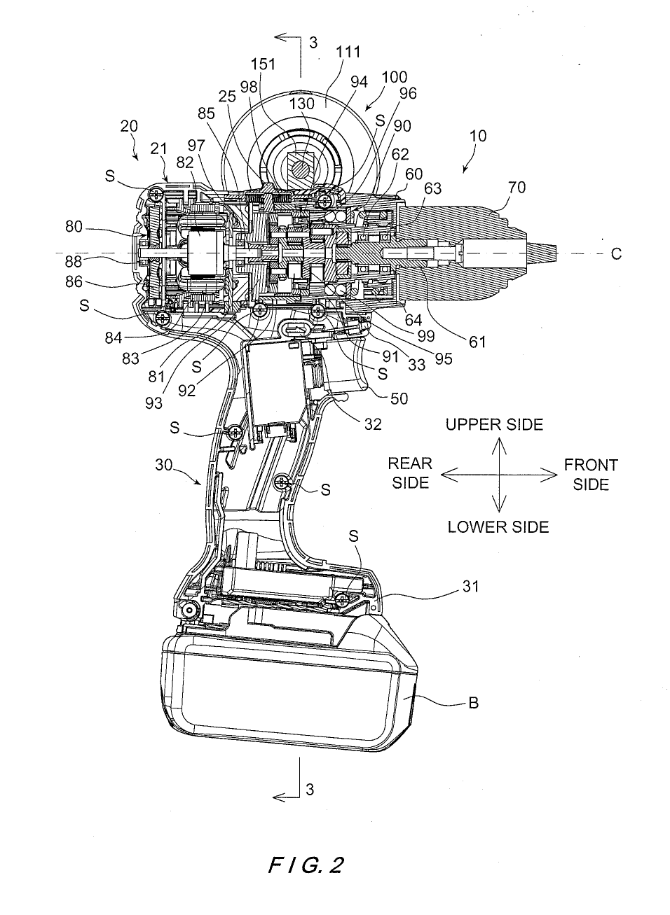

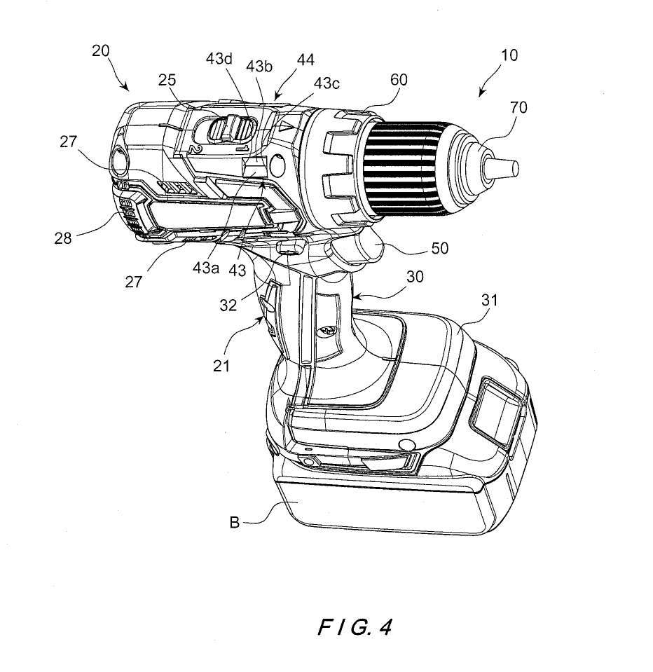

In the first embodiment illustrated in FIGS. 1 to 7, the power tool 10 is a cordless driver drill. As shown in FIGS. 1, 2 and 4, the power tool 10 has a generally pistol-like overall shape formed by a generally tubular main body portion 20 and a grip portion 30. The grip portion 30 extends downwardly from the main body portion 20 between a front end and a rear end of the main body portion 20. An outer surface of at least a part of the main body portion 20 and the grip portion 30 are integrally formed to define an outer housing cover 21. The outer housing cover 21 is preferably made of resin material. More specifically, the outer housing cover 21 includes a right housing cover 22 (one example of a right side housing part) and a left housing cover 23 (one example of a left side housing part). The right housing cover 22 and the left housing cover 23 are fixed together by a plurality of screws S (see, FIG. 2). Moreover, as shown in FIG. 4, the main body portion 20 includes a speed change lever 25 for changing a rotational speed of the power tool 10. The main body portion 20 further includes a plurality of openings defining front intake ports 27 and exhaust ports 28. Cooling air enters into the main body portion 20 through the front intake ports 27, and the cooling air is discharged from the exhaust ports 28, thereby forming cooling air passages that flow through inside of the main body portion 20 for cooling internal components accommodated in the main body portion 20.

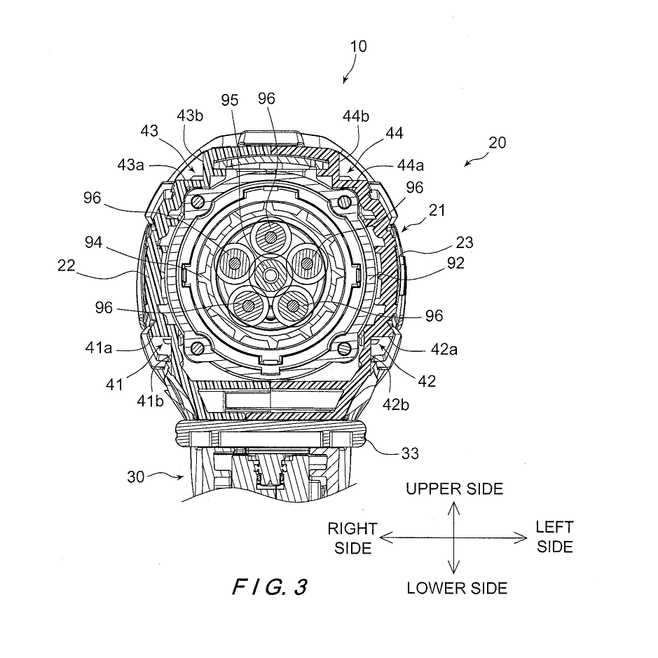

As shown in FIGS. 3 and 4, the main body portion 20 of the power tool 10 is provided with an auxiliary handle mounting structure including four recesses 41 to 44 formed in the outer housing cover 21. More specifically, as shown in FIGS. 3 and 4, a first recess 41 is formed in the right housing cover 22 in a lower region of the main body portion 20, a second recess 42 is formed in the left housing cover 23 in the lower region of the main body portion 20, a third recess 43 is formed in the right housing cover 22 in an upper region of the main body portion 20, and a fourth recess 44 is formed in the left housing cover 23 in the upper region of the main body portion 20. The first to fourth recesses 41 to 44 correspond to the first to fourth engagement structures of this embodiment. The first to fourth recesses 41 to 44 are integrally formed in the outer housing cover 21 (e.g., the respective one of the right housing cover 22 and the left housing cover 23) of the main body portion 20. For example, when the outer housing cover 21 of the power tool 10 is made as a molded member, the recesses 41 to 44 can be formed (molded) simultaneously along with other portions of the outer housing cover 21. Therefore, the recesses 41 to 44 can be formed on the power tool 10 in a simple manner without additional parts.

As shown in FIGS. 3 and 4, the first to fourth recesses 41 to 44 are aligned along a circumferential direction of the main body portion 20 while they are spaced apart from each other in the circumferential direction. As shown in FIGS. 3 and 4, the first to fourth recesses 41 to 44 are disposed on a vertical plane extending orthogonal to the center axis C of the main body portion 20, with the vertical plane at least partially passing through the grip portion 30 of the power tool 10.

Each of the first to fourth recesses 41 to 44 includes a pair of engagement surfaces that intersect to form about a right angle. More specifically, as shown in FIG. 3, the first recess 41 includes engagement surfaces 41a and 41b, the second recess 42 includes engagement surfaces 42a and 42b, the third recess 43 includes engagement surfaces 43a and 43b, and the fourth recess 44 includes engagement surfaces 44a and 44b. In the first embodiment, the engagement surfaces 41a, 42a, 43a and 44a of the first to fourth recesses 41 to 44 extend generally along a horizontal direction, and the engagement surfaces 41b, 42b, 43b and 44b of the first to fourth recesses 41 to 44 extend generally along a vertical direction. Each of the first to fourth recesses 41 to 44 further includes a front end wall disposed at front ends of the engagement surfaces and a rear end wall disposed at rear ends of the engagement surfaces. Although only a front end wall 43c and a rear end wall 43d of the third recess 43 are illustrated in FIG. 4, the structures of the first to fourth recesses 41 to 44 are basically the same.

As shown in FIGS. 1, 2 and 4, a trigger-type switch lever 50 is provided at an upper end region of the grip portion 30 for driving the power tool 10. A lower end of the grip portion 30 includes a battery connecting portion 31, which is coupled to a rechargeable battery B. The battery B serves as a power source for the power tool 10. Preferably, the rechargeable battery B is removably attached to the battery connecting portion 31 of the grip portion 30. The rechargeable battery B is a conventional battery such as a lithium-ion battery, a nickel cadmium battery, etc. A rotational direction change lever 32 is provided in a region where the grip portion 30 meets the main body portion 20 for switching a rotational direction of the power tool 10. A light unit 33 is provided in a front end of the region where the grip portion 30 meets the main body portion 20 for illuminating the work area.

A tubular change-ring 60 is disposed on a front side of the main body portion 20 so as to be rotatable about a center axis C of the main body portion 20 to adjust a rotation torque. The tubular change-ring 60 is coupled to a spindle 61. A power tool chuck 70 is attached around a front end part of the spindle 61 for holding a tool piece (not shown). The tool piece includes, for example, a drill bit, a screwdriver bit, etc.

As shown in FIG. 2, a motor unit 80 is disposed in a rear portion of the main body portion 20. In the power tool 10 of this example, the motor unit 80 constitutes a conventional brushless motor, which includes a rotor having a magnet 82, and a stator having stator coils 83 and a stator core 84. The motor unit 80 further includes conventional components such as a circuit board 81, an output shaft 85, a fan 86, and a rear bearing 88. In FIG. 2, some parts of the motor unit 80 (such as the magnet 82) are not shown in cross section for the sake of simplicity of illustration.

As shown in FIG. 2, a gear assembly 90 is disposed in front of the motor unit 80 inside the main body portion 20. The spindle 61 is coupled to the gear assembly 90 so that the gear assembly 90 transmits rotation of the output shaft 85 of the motor unit 80 to the power tool chuck 70 via the spindle 61, when the switch lever 50 is operated. More specifically, the gear assembly 90 includes a front gear box 91, a plurality of gears, a rear gear box 92, and a gear box lid 93. The plurality of gears includes an internal gear 94, a sun gear 95 and a plurality of planetary gears 96, etc. The spindle 61 is rotatably supported by a pair of bearings 62 and 63 that are fixed to the front gear box 91. A front bearing 97 is coupled to the gear box lid 93 for rotatably supporting the output shaft 85 of the motor unit 80. The speed change lever 25 is operatively coupled to the internal gear 94 via a connecting ring 98 so that a rotational speed of the power tool 10 (i.e., a rotational speed of the spindle 61) is changed by operating the speed change lever 25. In this example, a conventional torque adjustment mechanism (clutch mechanism) including a coli spring 64 and a plurality of balls 99 is provided for preventing overtightening beyond desired torque.

Since the components of the power tool 10, such as the tubular change ring 60, the power tool chuck 70, the motor unit 80 and the gear assembly 90, are conventional components that are well known in the art, the structure of these components will not be discussed or illustrated in detail herein. Rather, it will be apparent to those skilled in the art from this disclosure that the components of the power tool 10 can have any type of suitable structure.

Referring now to FIGS. 1, 2 and 5, the structure of the auxiliary handle member 100 will now be described. The auxiliary handle member 100 is an auxiliary tool that is removably coupled to the power tool 10 to provide a secondary grip portion for a user to support the power tool 10 with both hands during operation. The auxiliary handle member 100 basically includes an auxiliary grip portion 110 and a fixing portion 120. The fixing portion 120 is rotatably coupled to the auxiliary grip portion 110 by a fastening rod part 130 and a nut 140. The fixing portion 120 is configured and arranged to be fixed to the main body portion 20 of the power tool 10 as described in more detail below.

The fixing portion 120 is configured and arranged to fixedly couple the auxiliary grip portion 110 to the main body portion 20 of the power tool 10 with the fixing portion 120 surrounding about 270 degree of a circumference of the main body portion 20 when viewed along the longitudinal axis C of the main body portion 20 as shown in FIG. 7. In the first embodiment, the fixing portion 120 of the auxiliary handle member 100 is coupled to the main body portion 20 of the power tool 10 at four engagement locations that spread along about 270 degree of the circumference of the main body portion 20. Although the fixing portion 120 in the first embodiment is arranged to surround about 270 degree of the circumference of the main body portion 20, the angular range by which the fixing portion 120 surrounds the main body portion 20 is not limited to about 270 degree. More specifically, the fixing portion 120 is preferably arranged to surround more than 180 degree of the circumference of the main body portion 20 when viewed along the longitudinal axis C of the main body portion 20. With such an arrangement, rigid engagement between the fixing portion 120 and the main body portion 20 can be ensured, thereby preventing the auxiliary handle member 100 from accidentally slipping off or being misaligned with respect to the power tool 10 during operation of the power tool 10.

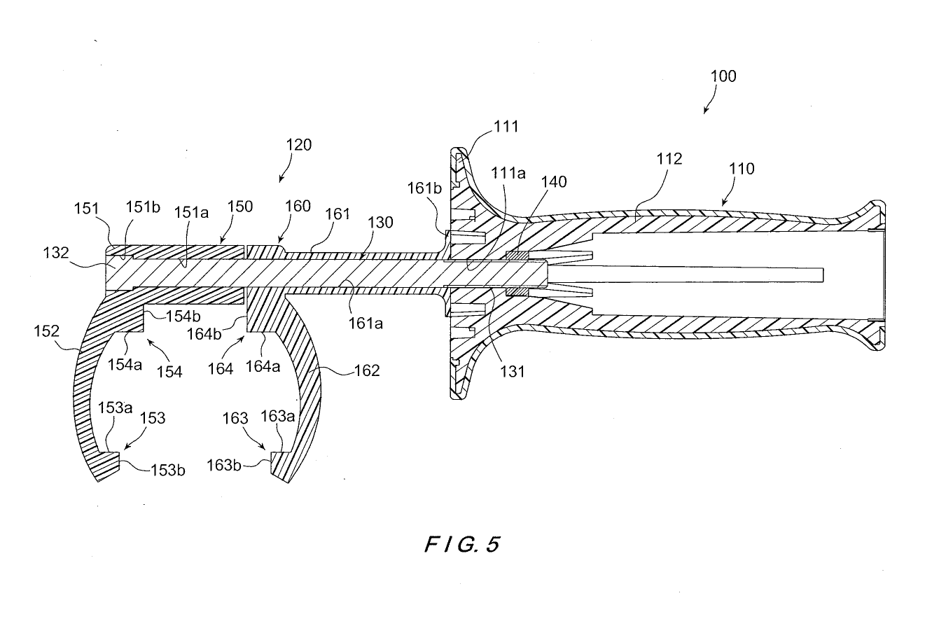

The auxiliary grip portion 110 of the auxiliary handle member 100 includes a flange section 111 and a body section 112. As shown in FIG. 5, a through-hole 111a is formed in the flange section 111 for passing the fastening rod part 130. The nut 140 engages with a threaded portion 131 formed in a proximate end of the fastening rod part 130 to fix the fastening rod part 130 to an inner end part of the through-hole 111a. An outer surface of the body section 112 is preferably made of rubber or plastic material, and may be provided with an anti-slip surface structure or coating to prevent the user's hand from slipping during operation.

The fixing portion 120 includes a first arm part 150 and a second arm part 160. The first arm part 150 includes a base portion 151 having a through hole 151a through which the fastening rod part 130 passes, and an arm portion 152 having a generally arcuate shape. A counterbore 151b is provided at a distal end of the through hole 151a so that a larger diameter portion 132 formed at a distal end of the fastening rod part 130 is fitted in the counterbore 151b so as to prevent the fastening rod part 130 from separating from the first arm part 150. The arm portion 152 of the first arm part 150 includes a lower protrusion 153 and an upper protrusion 154 that protrude inwardly from the arm portion 152. The lower protrusion 153 includes a pair of engagement surfaces 153a and 153b that intersect to form about a right angle. The upper protrusion 154 includes a pair of engagement surfaces 154a and 154b that intersect to form about a right angle. In the first embodiment, the engagement surfaces 153a and 154a of the lower protrusion 153 and the upper protrusion 154 extend generally along the horizontal direction, and the engagement surfaces 153b and 154b of the lower protrusion 153 and the upper protrusion 154 extend generally along the vertical direction. The lower protrusion 153 and the upper protrusion 154 are respectively disposed at positions corresponding to the first recess 41 and the third recess 43 formed in the main body portion 20 of the power tool 10 when the auxiliary handle member 100 is coupled to the power tool 10 as shown in FIG. 7. Therefore, when the auxiliary handle member 100 is coupled to the power tool 10, the engagement surfaces 153a and 153b of the lower protrusion 153 respectively abut against the engagement surfaces 41a and 41b of the first recess 41, and the engagement surfaces 154a and 154b of the upper protrusion 154 respectively abut against the engagement surfaces 43a and 43b of the third recess 43.

The second arm part 160 includes a base portion 161 having a generally cylindrical shape with a through hole 161a formed therein, and an arm portion 162 having a generally arcuate shape. The fastening rod part 130 slidably passes through the through hole 161a of the base portion 161. The base portion 161 of the second arm part 160 further includes a flange portion 161b that abuts against the flange section 111 of the auxiliary grip portion 110 of the auxiliary handle member 100. The arm portion 162 of the second arm part 160 includes a lower protrusion 163 and an upper protrusion 164 that protrude inwardly from the arm portion 162. The lower protrusion 163 includes a pair of engagement surfaces 163a and 163b that intersect to form about a right angle. The upper protrusion 164 includes a pair of engagement surfaces 164a and 164b that intersect to form about a right angle. In the first embodiment, the engagement surfaces 163a and 164a of the lower protrusion 163 and the upper protrusion 164 extend generally along the horizontal direction, and the engagement surfaces 163b and 164b of the lower protrusion 163 and the upper protrusion 164 extend generally along the vertical direction. The lower protrusion 163 and the upper protrusion 164 are respectively disposed at positions corresponding to the second recess 42 and the fourth recess 44 formed in the main body portion 20 of the power tool 10 when the auxiliary handle member 100 is coupled to the power tool 10 as shown in FIG. 7. Therefore, when the auxiliary handle member 100 is coupled to the power tool 10, the engagement surfaces 163a and 163b of the lower protrusion 163 respectively abut against the engagement surfaces 42a and 42b of the second recess 42, and the engagement surfaces 164a and 164b of the upper protrusion 164 respectively abut against the engagement surfaces 44a and 44b of the fourth recess 44.

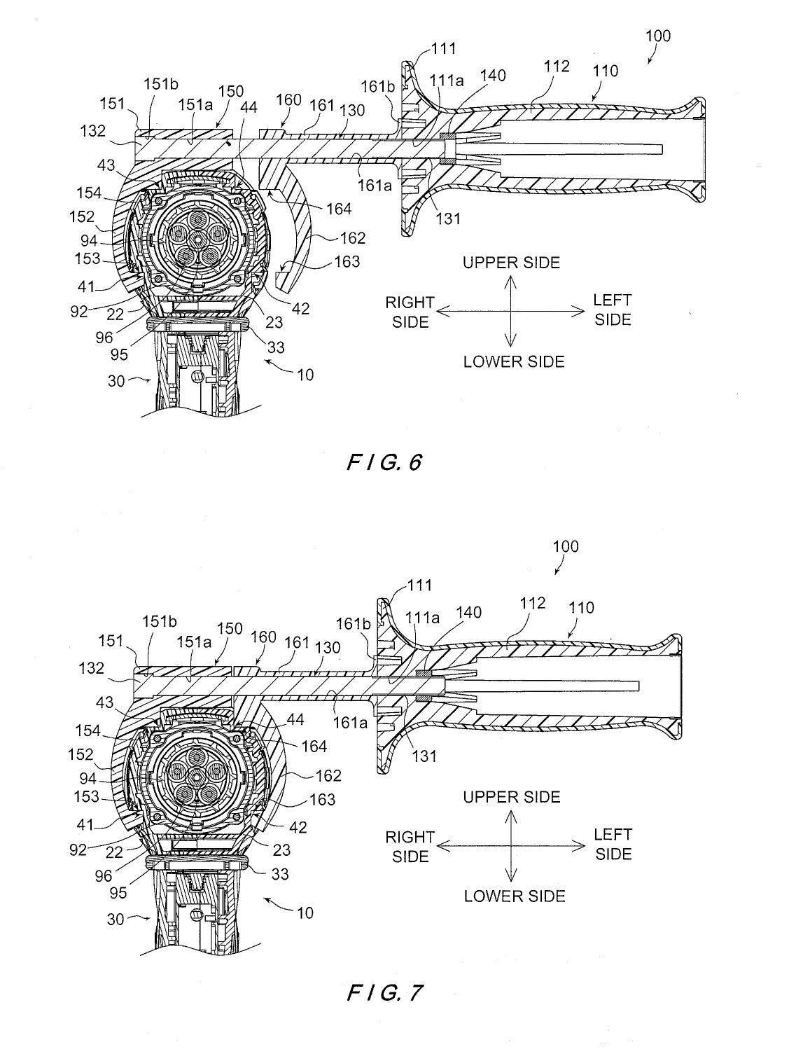

FIG. 6 shows the auxiliary handle member 100 and the power tool 10 when the fixing portion 120 of the auxiliary handle member 100 has not been fixed to the main body portion 20 of the power tool 10. FIG. 7 shows the auxiliary handle member 100 and the power tool 10 when the fixing portion 120 of the auxiliary handle member 100 is fixed to the main body portion 20 of the power tool 10.

In a state in which the auxiliary handle member 100 has not been fixed to the power tool 10 as shown in FIG. 6, the second arm part 160 is movable relative to the first arm part 150 along a linear path as the second arm part 160 slides along the fastening rod part 130 in an axial direction of the fastening rod part 130. When the auxiliary grip portion 110 is rotated around the fastening rod part 130 while the nut 140 threadedly engages with the threaded portion 131 of the fastening rod part 130, the fastening rod part 130 moves in the axial direction. The second arm part 160 also moves along with the fastening rod part 130 in a direction away from or toward the first arm part 150 depending on the rotation direction of the fastening rod part 130 with respect to the nut 140. Therefore, the distance between the first arm part 150 and the second arm part 160 (e.g., the distance between the lower protrusion 153 of the first arm part 150 and the lower protrusion 163 of the second arm part 160) increases or decreases as the auxiliary grip portion 110 is rotated with respect to the fixing portion 120.

More specifically, the distance between the first arm part 150 and the second arm part 160 decreases as the fastening rod part 130 is retracted in the auxiliary grip portion 110. Therefore, before the auxiliary handle member 100 is attached to the power tool 10, the auxiliary grip portion 110 is rotated in a first direction (e.g., counterclockwise) with respect to the fixing portion 120 to move the fastening rod part 130 in a direction in which the fastening rod part 130 protrudes from the auxiliary grip portion 110, and the second arm part 160 is separated from the first arm part 150. At this time, a sufficient distance is formed between the lower protrusion 153 of the first arm part 150 and the lower protrusion 163 of the second arm part 160 so that the main body portion 20 of the power tool 10 is inserted between the first arm part 150 and the second arm part 160 as shown in FIG. 6. The auxiliary handle member 100 is positioned with respect to the power tool 10 so that the lower protrusion 153 and the upper protrusion 154 of the first arm part 150 respectively engage the first recess 41 and the third recess 43 as shown in FIG. 6. Then, the auxiliary grip portion 110 of the auxiliary handle member 100 is turned in a second direction (e.g., clockwise) with respect to the fixing portion 120 to move the fastening rod part 130 in a direction in which the fastening rod part 130 is retracted toward the auxiliary grip portion 110. As the fastening rod part 130 moves, the flange section 111 of the auxiliary grip portion 110 pushes the flange portion 161b of the second arm part 160 so that the second arm part 160 slides along the fastening rod part 130 toward the first arm part 150. Therefore, the main body portion 20 of the power tool 10 is clamped between the first arm part 150 and the second arm part 160. This clamping force imparted on the main body portion 20 of the power tool 10 by the fixing portion 120 of the auxiliary handle member 100 further prevents the right housing cover 22 and the second housing cover 23 from separating from each other. At this time, the lower protrusion 163 and the upper protrusion 164 of the second arm part 160 respectively engage with the second recess 42 and the fourth recess 44 of the main body portion 20. Moreover, as the lower protrusion 153, the lower protrusion 163, the upper protrusion 154 and the upper protrusion 164 respectively engage with the first to fourth recesses 41 to 44, movement of the first and second arm parts 150 and 160 in the axial direction along the center axis C is restricted by the front end wall and the rear end wall of each of the first to fourth recesses 41 to 44. Therefore, both rotational movement and axial movement of the auxiliary handle member 100 relative to the main body portion 20 of the power tool 10 are prevented by engagement between the lower protrusion 153 and the first recess 41, between the lower protrusion 163 and the second recess 42, between the upper protrusion 154 and the third recess 43 and between the upper protrusion 164 and the fourth recess 44.

As shown in FIGS. 2 and 7, the fixing portion 120 of the auxiliary handle member 100 is coupled to the main body portion 20 of the power tool 10 at a position corresponding to a location where the rear gear box 92, the internal gear 94, the sun gear 95 and the planetary gears 96 of the gear assembly 90 are disposed. In other words, as shown in FIG. 7, the rear gear box 92, the internal gear 94, the sun gear 95 and the planetary gears 96 are disposed on a radial inner side of the first arm part 150 and the second arm part 160 of the fixing portion 120. Therefore, it is not necessary to provide an extra space in the front portion of the main body portion 20 to mount the auxiliary handle member 100. Accordingly, the overall longitudinal length of the main body portion 20 of the power tool 10 can be prevented from being increased.

Moreover, with the power tool assembly according to the first embodiment, the first to fourth recesses 41 to 44 are disposed on the vertical plane that at least partially passes through the grip portion 30 of the power tool 10. Therefore, when the auxiliary handle member 100 is fixed to the power tool 10, the grip portion 30 of the power tool 10 and the auxiliary grip portion 110 of the auxiliary handle member 100 are generally aligned along the circumferential direction of the main body portion 20. With this arrangement, it is easier to gain sufficient leverage to properly operate the power tool by holding the power tool 10 by two grip portions that are disposed at generally equal distance from the work piece. Moreover, with the power tool 10 according to the first embodiment, it is not necessary to provide an extra space in the front portion of the main body portion 20 for forming the auxiliary handle mounting structure (e.g., the first to fourth recesses 41 to 44). In other words, the existing space on the main body portion 20 can be efficiently used to form the auxiliary handle mounting structure. Therefore, the overall longitudinal length of the main body portion 20 of the power tool 10 can be prevented from being increased. Thus, the usability of the power tool 10 with the auxiliary handle member 100 is improved even in a confined working space. Moreover, since the auxiliary handle member 100 is attached at generally the same axial position as the grip portion 30, the auxiliary handle member 100 is prevented from interfering with a target workpiece even when the target workpiece has a shape that bulges out towards the power tool 10.

Moreover, the fixing portion 120 of the auxiliary handle member 100 according to the first embodiment is arranged to surround more than 180 degree of the circumference of the main body portion 20 when viewed along the longitudinal axis C of the main body portion 20 as shown in FIG. 7. With such an arrangement, rigid engagement between the fixing portion 120 and the main body portion 20 can be ensured, thereby preventing the auxiliary handle member 100 from accidentally slipping off or being misaligned with respect to the power tool 10 during operation of the power tool 10.

### Second Embodiment

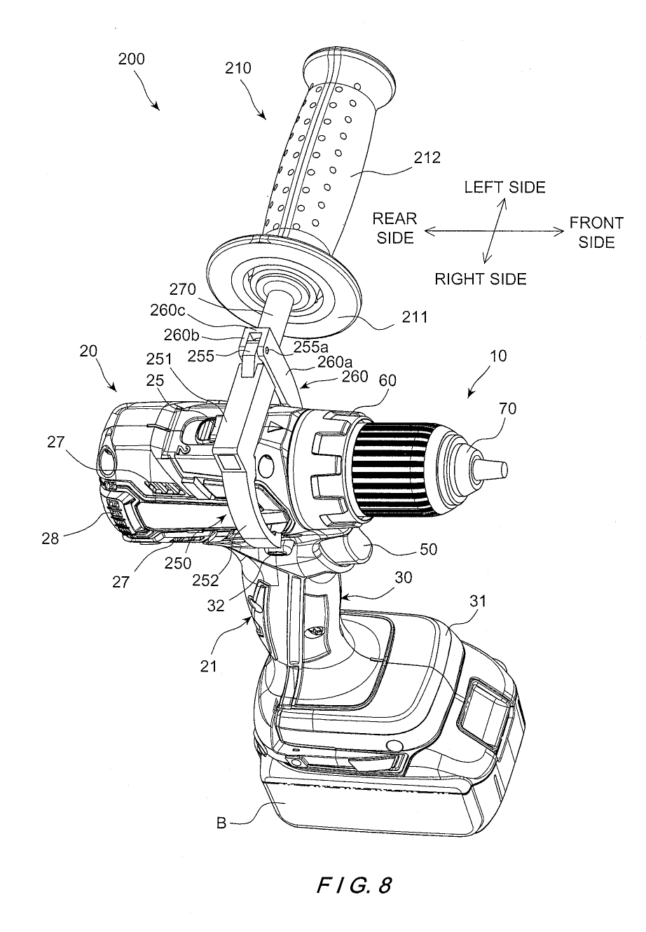

Referring now to FIGS. 8-11, a power tool assembly including the power tool 10 and an auxiliary handle member 200 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The power tool assembly according to the second embodiment differs from the first embodiment in the structure of the auxiliary handle member 200. In other words, in the second embodiment, the auxiliary handle member 200 is selectively coupled to the power tool 10 to provide a secondary grip position for a user to support the power tool 10 with both hands during operation.

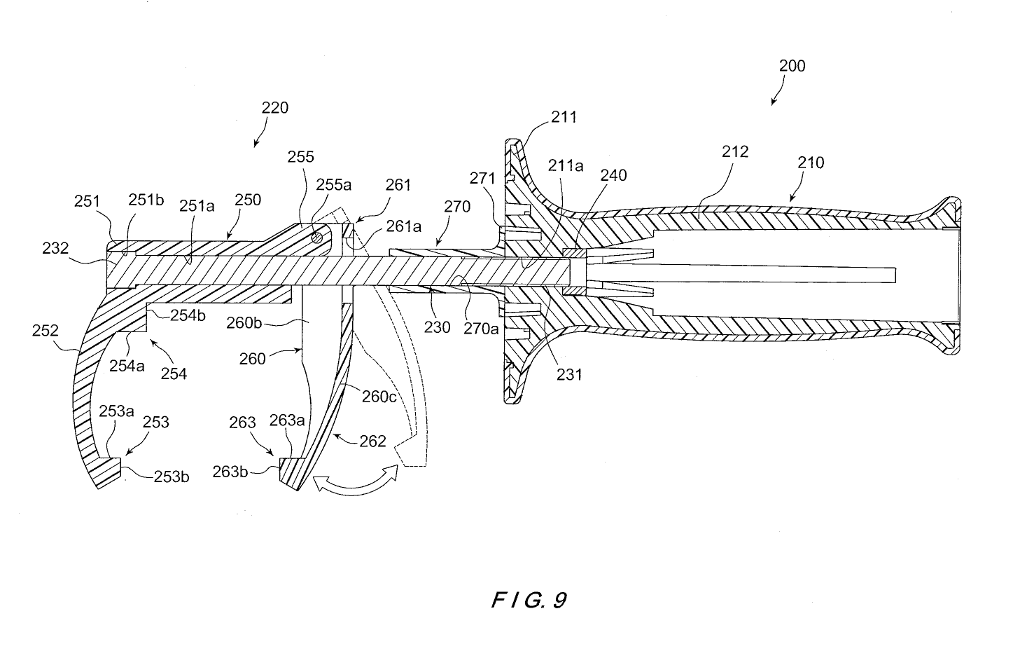

Referring now to FIGS. 8 and 9, the structure of the auxiliary handle member 200 will now be described. The auxiliary handle member 200 basically includes an auxiliary grip portion 210 and a fixing portion 220. The fixing portion 220 is rotatably coupled to the auxiliary grip portion 210 by a fastening rod part 230 and a nut 240. The fixing portion 220 is configured and arranged to be fixed to the main body portion 20 of the power tool 10 as described in more detail below. The auxiliary handle member 200 of the second embodiment also includes a sleeve member 270 disposed between the auxiliary grip portion 210 and the fixing portion 220.

The fixing portion 220 is configured and arranged to fixedly couple the auxiliary grip portion 210 to the main body portion 20 of the power tool 10 with the fixing portion 220 surrounding about 270 degree of a circumference of the main body portion 20 when viewed along the longitudinal axis C of the main body portion 20 as shown in FIG. 11. In the second embodiment, the fixing portion 220 of the auxiliary handle member 200 is coupled to the main body portion 20 of the power tool 10 at three engagement locations that spread along about 270 degree of the circumference of the main body portion 20. Although the fixing portion 220 in the second embodiment is arranged to surround about 270 degree of the circumference of the main body portion 20, the angular range by which the fixing portion 220 surrounds the main body portion 20 is not limited to about 270 degree. More specifically, the fixing portion 220 is preferably arranged to surround more than 180 degree of the circumference of the main body portion 20 when viewed along the longitudinal axis C of the main body portion 20. With such an arrangement, rigid engagement between the fixing portion 220 and the main body portion 20 can be ensured, thereby preventing the auxiliary handle member 200 from accidentally slipping off or being misaligned with respect to the power tool 10 during operation of the power tool 10.

The auxiliary grip portion 210 of the auxiliary handle member 200 includes a flange section 211 and a body section 212. As shown in FIG. 9, a through-hole 211a is formed in the flange section 211 for passing the fastening rod part 230. The nut 240 engages with a threaded portion 231 formed in a proximate end of the fastening rod part 230 to fix the fastening rod part 230 to an inner end part of the through-hole 211a. An outer surface of the body section 212 is preferably made of rubber or plastic material, and may be provided with an anti-slip surface structure or coating to prevent the user's hand from slipping during operation.

The sleeve member 270 is a generally cylindrical member having a through hole 270a through which the fastening rod part 230 slidably passes. The sleeve member 270 includes a flange portion 271 that abuts against the flange section 211 of the auxiliary grip portion 210.

The fixing portion 220 includes a first arm part 250 and a second arm part 260. The first arm part 250 includes a base portion 251 having a through hole 251a through which the fastening rod part 230 passes, and an arm portion 252 having a generally arcuate shape. A counterbore 251b is provided at a distal end of the through hole 251a so that a larger diameter portion 232 formed at a distal end of the fastening rod part 230 is fitted in the counterbore 251b so as to prevent the fastening rod part 230 from separating from the first arm part 250. The arm portion 252 of the first arm part 250 includes a lower protrusion 253 and an upper protrusion 254 that protrude inwardly from the arm portion 252. The lower protrusion 253 includes a pair of engagement surfaces 253a and 253b that intersect to form about a right angle. The upper protrusion 254 includes a pair of engagement surfaces 254a and 254b that intersect to form about a right angle. In the second embodiment, the engagement surfaces 253a and 254a of the lower protrusion 253 and the upper protrusion 254 extend generally along the horizontal direction, and the engagement surfaces 253b and 254b of the lower protrusion 253 and the upper protrusion 254 extend generally along the vertical direction. The lower protrusion 253 and the upper protrusion 254 are respectively disposed at positions corresponding to the first recess 41 and the third recess 43 formed in the main body portion 20 of the power tool 10 when the auxiliary handle member 200 is coupled to the power tool 10 as shown in FIG. 11. Therefore, when the auxiliary handle member 200 is coupled to the power tool 10, the engagement surfaces 253a and 253b of the lower protrusion 253 respectively abut against the engagement surfaces 41a and 41b of the first recess 41, and the engagement surfaces 254a and 254b of the upper protrusion 254 respectively abut against the engagement surfaces 43a and 43b of the third recess 43.

The first arm part 250 of the second embodiment further includes an attachment portion 255 that extends from the base portion 251. The attachment portion 255 is coupled to the second arm part 260 via a pivot pin 255a so that the second arm part 260 is pivotable with respect to the first arm part 250 about the pivot pin 255a.

As shown in FIG. 8, the second arm part 260 is formed by a pair of plate sections 260a and 260b spaced apart from each other, and a connecting wall section 260c extending between the plate sections 260a and 260b. A gap is formed between the plate sections 260a and 260b so that the attachment portion 255 of the first arm part 250 is disposed between the plate sections 260a and 260b. The plate sections 260a and 260b of the second arm part 260 are pivotally coupled to the attachment portion 255 of the first arm part 250 by the pivot pin 255a.

The second arm part 260 includes a base portion 261 and an arm portion 262 having a generally arcuate shape. A guide aperture 261a is formed in the connecting wall section 260c in the base portion 261 of the second arm part 260 as shown in FIG. 9. The guide aperture 261a has an elongated shape having a transverse width that is slightly larger than an outer diameter of the fastening rod part 230 and smaller than an outer diameter of the sleeve member 270. A longitudinal length of the guide aperture 261a is set to be larger (e.g., about twice as large) than the outer diameter of the fastening rod part 230. Therefore, when there is a sufficient distance between the auxiliary grip portion 210 and the fixing portion 220 as shown in FIG. 9, the second arm part 260 is movable with respect to the fastening rod part 230 as the fastening rod part 230 slides within the guide aperture 261a. In other words, the second arm part 260 is movable with respect to the first arm part 250 along an arcuate path as the second arm part 260 pivots about the pivot pin 255a.

The arm portion 262 of the second arm part 260 includes a lower protrusion 263 that protrudes inwardly from the arm portion 262. The lower protrusion 263 includes a pair of engagement surfaces 263a and 263b that intersect to form about a right angle. In the second embodiment, the engagement surface 263a of the lower protrusion 263 extends generally along the horizontal direction, and the engagement surface 263b of the lower protrusion 263 extends generally along the vertical direction. The lower protrusion 263 is disposed at a position corresponding to the second recess 42 formed in the main body portion 20 of the power tool 10 when the auxiliary handle member 200 is coupled to the power tool 10 as shown in FIG. 11. Therefore, when the auxiliary handle member 200 is coupled to the power tool 10, the engagement surfaces 263a and 263b of the lower protrusion 263 respectively abut against the engagement surfaces 42a and 42b of the second recess 42.

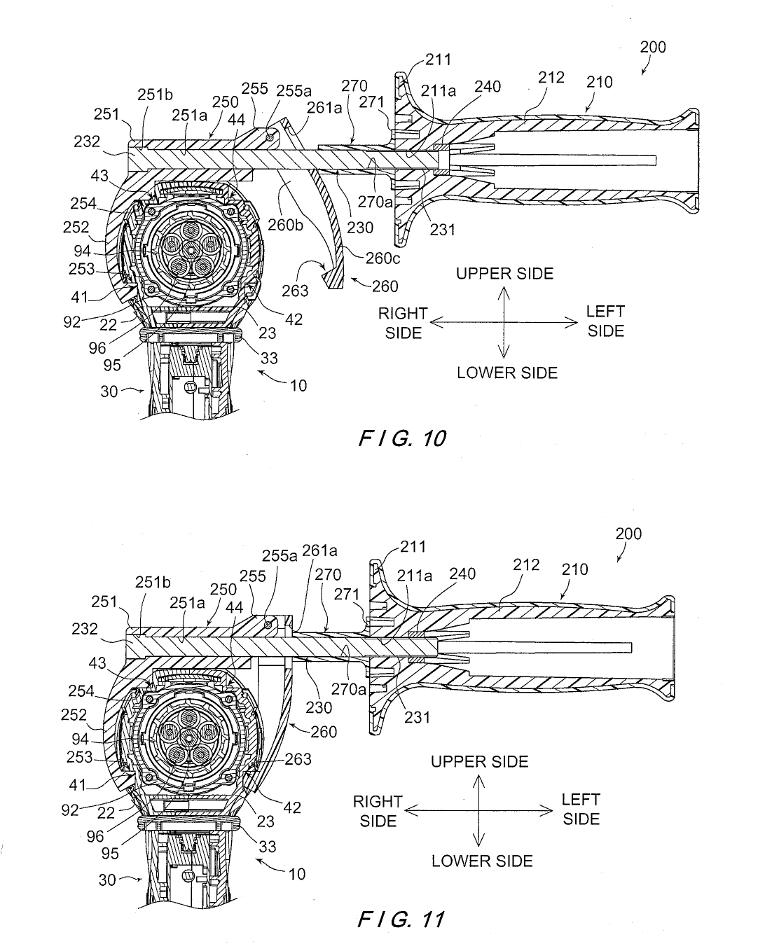

FIG. 10 shows the auxiliary handle member 200 and the power tool 10 when the fixing portion 220 of the auxiliary handle member 200 has not been fixed to the main body portion 20 of the power tool 10. FIG. 11 shows the auxiliary handle member 200 and the power tool 10 when the fixing portion 220 of the auxiliary handle member 200 is fixed to the main body portion 20 of the power tool 10.

In a state in which the auxiliary handle member 200 has not been fixed to the power tool 10 as shown in FIG. 10, the second arm part 260 is movable relative to the first arm part 250 along an arcuate path as the second arm part 260 pivots about the pivot pin 255a. Therefore, the distance between the lower protrusion 253 of the first arm part 250 and the lower protrusion 263 of the second arm part 260 increases or decreases as the second arm part 260 pivots with respect to the first arm part 250.

When the auxiliary grip portion 210 is rotated around the fastening rod part 230 while the nut 240 threadedly engages with the threaded portion 231 of the fastening rod part 230, the fastening rod part 230 moves in the axial direction. Therefore, before the auxiliary handle member 200 is attached to the power tool 10, the auxiliary grip portion 210 is rotated in a first direction (e.g., counterclockwise) with respect to the fixing portion 220 to move the fastening rod part 230 in a direction in which the fastening rod part 230 protrudes from the auxiliary grip portion 210 to increase the distance between the auxiliary grip portion 210 and the fixing portion 220. Thus, the second arm part 260 is pivotable with respect to the first arm part 250 as shown in FIG. 10. At this time, a sufficient distance is formed between the lower protrusion 253 of the first arm part 250 and the lower protrusion 263 of the second arm part 260 so that the main body portion 20 of the power tool 10 is inserted between the first arm part 250 and the second arm part 260. The auxiliary handle member 200 is positioned with respect to the power tool 10 so that the lower protrusion 253 and the upper protrusion 254 of the first arm part 250 respectively engage the first recess 41 and the third recess 43 as shown in FIG. 10.

Next, the auxiliary grip portion 210 of the auxiliary handle member 200 is turned in a second direction (e.g., clockwise) with respect to the fixing portion 220 to move the fastening rod part 230 in a direction in which the fastening rod part 230 is retracted toward the auxiliary grip portion 210. As the fastening rod part 230 moves, the flange section 211 of the auxiliary grip portion 210 pushes the flange portion 271 of the sleeve member 270 so that the sleeve member 270 slides along the fastening rod part 230 toward the second arm part 260. Since the guide aperture 261a formed in the connecting wall section 260c of the second arm part 260 has the transverse width smaller than the outer diameter of the sleeve member 270, the distal end of the sleeve member 270 presses against the connecting wall section 260c of the second arm part 260 towards the first arm part 250 as the fastening rod part 230 is rotated. Therefore, the main body portion 20 of the power tool 10 is clamped between the first arm part 250 and the second arm part 260. This clamping force imparted on the main body portion 20 of the power tool 10 by the fixing portion 220 of the auxiliary handle member 200 further prevents the right housing cover 22 and the second housing cover 23 from separating from each other. At this time, the lower protrusion 263 of the second arm part 260 engages with the second recess 42 of the main body portion 20. Moreover, as the lower protrusion 253, the lower protrusion 263 and the upper protrusion 254 respectively engage with the first to third recesses 41 to 43, movement of the first and second arm parts 250 and 260 in the axial direction along the center axis C is restricted by the front end wall and the rear end wall of each of the first to third recesses 41 to 43. Therefore, both rotational movement and axial movement of the auxiliary handle member 200 relative to the main body portion 20 of the power tool 10 are prevented by engagement between the lower protrusion 253 and the first recess 41, between the lower protrusion 263 and the second recess 42, and between the upper protrusion 254 and the third recess 43.

With the power tool assembly according to the second embodiment, the similar effects as the first embodiment can be obtained. More specifically, as shown in FIG. 11, the rear gear box 92, the internal gear 94, the sun gear 95 and the planetary gears 96 are disposed on a radial inner side of the first arm part 250 and the second arm part 260 of the fixing portion 220. Therefore, it is not necessary to provide an extra space in the front portion of the main body portion 20 to mount the auxiliary handle member 200. Accordingly, the overall longitudinal length of the main body portion 20 of the power tool 10 can be prevented from being increased.

Moreover, since the fixing portion 220 of the auxiliary handle member 200 according to the second embodiment is arranged to surround more than 180 degree of the circumference of the main body portion 20 when viewed along the longitudinal axis C of the main body portion 20 as shown in FIG. 11, rigid engagement between the fixing portion 220 and the main body portion 20 can be ensured, thereby preventing the auxiliary handle member 200 from accidentally slipping off or being misaligned with respect to the power tool 10 during operation of the power tool 10.

### Third Embodiment

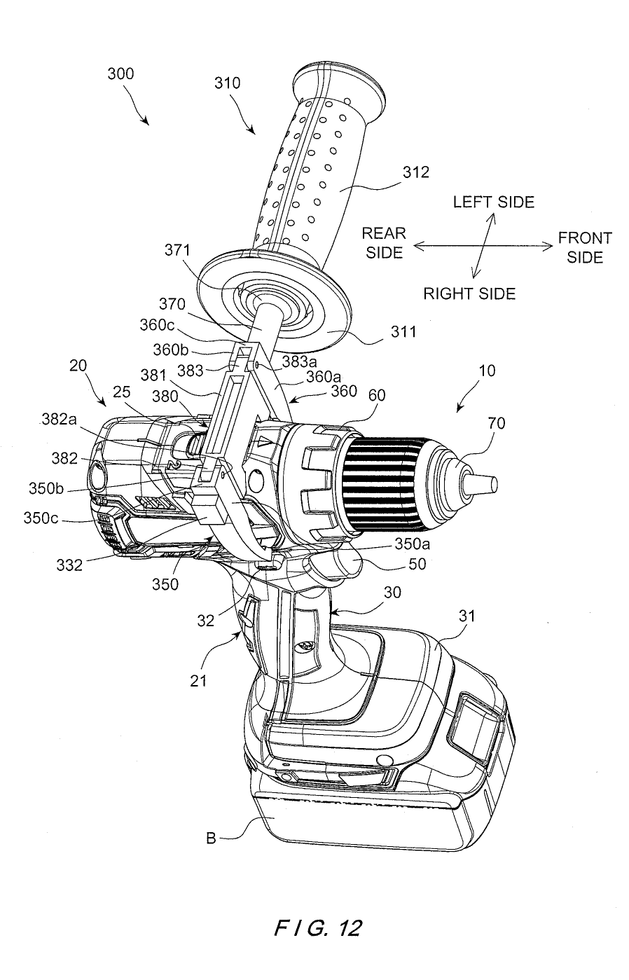

Referring now to FIGS. 12-15, a power tool assembly including the power tool 10 and an auxiliary handle member 300 in accordance with a third embodiment will now be explained. In view of the similarity between the first, second and third embodiments, the parts of the third embodiment that are identical to the parts of the first or second embodiment will be given the same reference numerals as the parts of the first or second embodiment. Moreover, the descriptions of the parts of the third embodiment that are identical to the parts of the first or second embodiment may be omitted for the sake of brevity.

The power tool assembly according to the third embodiment differs from the first embodiment in the structure of the auxiliary handle member 300. In other words, in the second embodiment, the auxiliary handle member 300 is selectively coupled to the power tool 10 to provide a secondary grip position for a user to support the power tool 10 with both hands during operation.

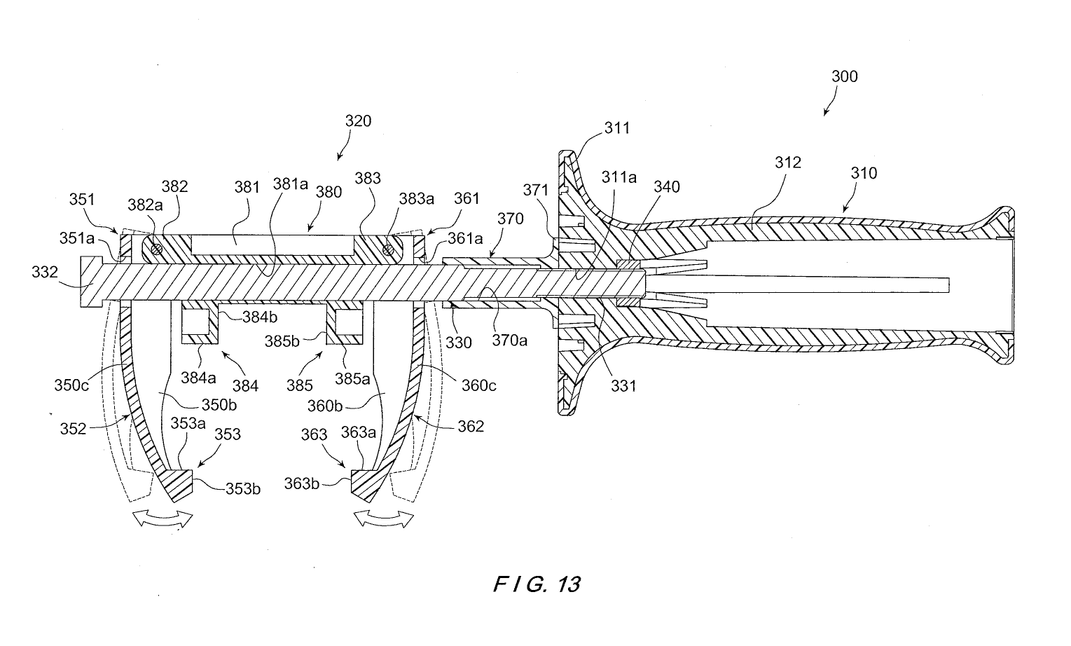

Referring now to FIGS. 12 and 13, the structure of the auxiliary handle member 300 will now be described. The auxiliary handle member 300 basically includes an auxiliary grip portion 310 and a fixing portion 320. The fixing portion 320 is rotatably coupled to the auxiliary grip portion 310 by a fastening rod part 330 and a nut 340. The fixing portion 320 is configured and arranged to be fixed to the main body portion 20 of the power tool 10 as described in more detail below. The auxiliary handle member 300 of the third embodiment also includes a sleeve member 370 disposed between the auxiliary grip portion 310 and the fixing portion 320.

The fixing portion 320 is configured and arranged to fixedly couple the auxiliary grip portion 310 to the main body portion 20 of the power tool 10 with the fixing portion 320 surrounding about 270 degree of a circumference of the main body portion 20 when viewed along the longitudinal axis C of the main body portion 20 as shown in FIG. 15. In the third embodiment, the fixing portion 320 of the auxiliary handle member 300 is coupled to the main body portion 20 of the power tool 10 at four engagement locations that spread along about 270 degree of the circumference of the main body portion 20. Although the fixing portion 320 in the third embodiment is arranged to surround about 270 degree of the circumference of the main body portion 20, the angular range by which the fixing portion 320 surrounds the main body portion 20 is not limited to about 270 degree. More specifically, the fixing portion 320 is preferably arranged to surround more than 180 degree of the circumference of the main body portion 20 when viewed along the longitudinal axis C of the main body portion 20. With such an arrangement, rigid engagement between the fixing portion 320 and the main body portion 20 can be ensured, thereby preventing the auxiliary handle member 300 from accidentally slipping off or being misaligned with respect to the power tool 10 during operation of the power tool 10.

The auxiliary grip portion 310 of the auxiliary handle member 300 includes a flange section 311 and a body section 312. As shown in FIG. 13, a through-hole 311a is formed in the flange section 311 for passing the fastening rod part 330. The nut 340 engages with a threaded portion 331 formed in a proximate end of the fastening rod part 330 to fix the fastening rod part 330 to an inner end part of the through-hole 311a. An outer surface of the body section 312 is preferably made of rubber or plastic material, and may be provided with an anti-slip surface structure or coating to prevent the user's hand from slipping during operation.

The sleeve member 370 is a generally cylindrical member having a through hole 370a through which the fastening rod part 330 slidably passes. The sleeve member 370 includes a flange portion 371 that abuts against the flange section 311 of the auxiliary grip portion 310.

The fixing portion 320 includes a first arm part 350, a second arm part 360 and a bracket part 380 disposed between the first arm part 350 and the second arm part 360.

As shown in FIG. 13, the bracket part 380 includes a base portion 381 having a through hole 381a through which the fastening rod part 330 slidably passes. The bracket part 380 further includes a first attachment portion 382 that extends from the base portion 381 toward the first arm part 350, and a second attachment portion 383 that extends from the base portion 381 toward the second arm part 360. The first attachment portion 382 is coupled to the first arm part 350 via a first pivot pin 382a so that the first arm part 350 is pivotable with respect to the bracket part 380 about the first pivot pin 382a. The second attachment portion 383 is coupled to the second arm part 360 via a second pivot pin 383a so that the second arm part 360 is pivotable with respect to the bracket part 380 about the second pivot pin 383a.

The bracket part 380 further includes a first upper protrusion 384 and a second upper protrusion 385 extending inwardly from the base portion 381 as shown in FIG. 13. The first upper protrusion 384 includes a pair of engagement surfaces 384a and 384b that intersect to form about a right angle. The second upper protrusion 385 includes a pair of engagement surfaces 385a and 385b that intersect to form about a right angle. In the third embodiment, the engagement surfaces 384a and 385a of the first and second upper protrusions 384 and 385 extend generally along the horizontal direction, and the engagement surfaces 384b and 385b of the first and second upper protrusions 384 and 385 extend generally along the vertical direction. The first upper protrusion 384 and the second upper protrusion 385 are respectively disposed at positions corresponding to the third recess 43 and the fourth recess 44 formed in the main body portion 20 of the power tool 10 when the auxiliary handle member 100 is coupled to the power tool 10 as shown in FIG. 15. Therefore, when the auxiliary handle member 100 is coupled to the power tool 10, the engagement surfaces 384a and 384b of the first upper protrusion 384 respectively abut against the engagement surfaces 43a and 43b of the third recess 43, and the engagement surfaces 385a and 385b of the second upper protrusion 385 respectively abut against the engagement surfaces 44a and 44b of the fourth recess 44.

As shown in FIG. 12, the first arm part 350 is formed by a pair of plate sections 350a and 350b spaced apart from each other, and a connecting wall section 350c extending between the plate sections 350a and 350b. A gap is formed between the plate sections 350a and 350b so that the first attachment portion 382 of the bracket part 380 is disposed between the plate sections 350a and 350b. The plate sections 350a and 350b of the first arm part 350 are pivotally coupled to the first attachment portion 382 of the bracket part 380 by the first pivot pin 382a.

The first arm part 350 includes a base portion 351 and an arm portion 352 having a generally arcuate shape. A guide aperture 351a is formed in the connecting wall section 350c in the base portion 351 of the first arm part 350 as shown in FIG. 13. The guide aperture 351a has an elongated shape having a transverse width that is slightly larger than an outer diameter of the fastening rod part 330 and smaller than an outer diameter of a larger diameter portion of formed at a distal end of the fastening rod part 330. A longitudinal length of the guide aperture 351a is set to be larger than the outer diameter of the fastening rod part 330. Therefore, when there is a sufficient distance between the larger diameter portion 332 and the first arm part 350 as shown in FIG. 13, the first arm part 350 is movable with respect to the fastening rod part 330 as the fastening rod part 330 slides within the guide aperture 351a. In other words, the first arm part 350 is movable with respect to the bracket part 380 along an arcuate path as the first arm part 350 pivots about the first pivot pin 382a.

The arm portion 352 of the first arm part 350 includes a lower protrusion 353 that protrudes inwardly from the arm portion 352. The lower protrusion 353 includes a pair of engagement surfaces 353a and 353b that intersect to form about a right angle. In the third embodiment, the engagement surface 353a of the lower protrusion 353 extends generally along the horizontal direction, and the engagement surface 353b of the lower protrusion 353 extends generally along the vertical direction. The lower protrusion 353 is disposed at a position corresponding to the first recess 41 formed in the main body portion 20 of the power tool 10 when the auxiliary handle member 300 is coupled to the power tool 10 as shown in FIG. 15. Therefore, when the auxiliary handle member 300 is coupled to the power tool 10, the engagement surfaces 353a and 353b of the lower protrusion 353 respectively abut against the engagement surfaces 41a and 41b of the first recess 41.

As shown in FIG. 13, the second arm part 360 is basically a mirror image of the first arm part 350. More specifically, as shown in FIG. 12 the second arm part 360 is formed by a pair of plate sections 360a and 360b spaced apart from each other, and a connecting wall section 360c extending between the plate sections 360a and 360b. A gap is formed between the plate sections 360a and 360b so that the second attachment portion 383 of the bracket part 380 is disposed between the plate sections 360a and 360b. The plate sections 360a and 360b of the second arm part 360 are pivotally coupled to the second attachment portion 383 of the bracket part 380 by the second pivot pin 383a.

The second arm part 360 includes a base portion 361 and an arm portion 362 having a generally arcuate shape. A guide aperture 361a is formed in the connecting wall section 360c in the base portion 361 of the second arm part 360 as shown in FIG. 13. The guide aperture 361a has an elongated shape having a transverse width that is slightly larger than the outer diameter of the fastening rod part 330 and smaller than an outer diameter of the sleeve member 370. A longitudinal length of the guide aperture 361a is set to be larger than the outer diameter of the fastening rod part 330. Therefore, when there is a sufficient distance between the larger diameter portion 332 and the second arm part 360 as shown in FIG. 13, the second arm part 360 is movable with respect to the fastening rod part 330 as the fastening rod part 330 slides within the guide aperture 361a. In other words, the second arm part 360 is movable with respect to the bracket part 380 along an arcuate path as the second arm part 360 pivots about the second pivot pin 383a.

The arm portion 362 of the second arm part 360 includes a lower protrusion 363 that protrudes inwardly from the arm portion 362. The lower protrusion 363 includes a pair of engagement surfaces 363a and 363b that intersect to form about a right angle. In the third embodiment, the engagement surface 363a of the lower protrusion 363 extends generally along the horizontal direction, and the engagement surface 363b of the lower protrusion 363 extends generally along the vertical direction. The lower protrusion 363 is disposed at a position corresponding to the second recess 42 formed in the main body portion 20 of the power tool 10 when the auxiliary handle member 300 is coupled to the power tool 10 as shown in FIG. 15. Therefore, when the auxiliary handle member 300 is coupled to the power tool 10, the engagement surfaces 363a and 363b of the lower protrusion 363 respectively abut against the engagement surfaces 42a and 42b of the second recess 42.

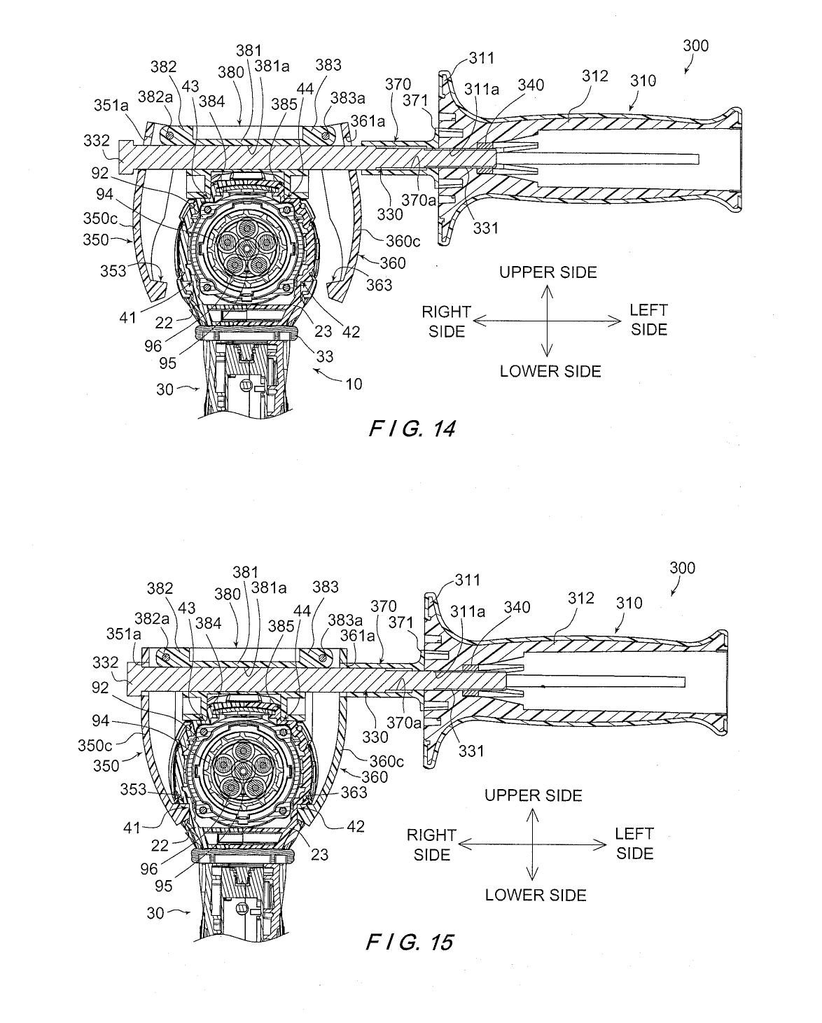

FIG. 14 shows the auxiliary handle member 300 and the power tool 10 when the fixing portion 320 of the auxiliary handle member 300 has not been fixed to the main body portion 20 of the power tool 10. FIG. 15 shows the auxiliary handle member 300 and the power tool 10 when the fixing portion 320 of the auxiliary handle member 300 is fixed to the main body portion 20 of the power tool 10.

In a state in which the auxiliary handle member 300 has not been fixed to the power tool 10 as shown in FIG. 14, the first arm part 350 and the second arm part 360 are movable relative to the bracket part 380 along the arcuate paths as the first arm part 350 pivots about the first pivot pin 382a and the second arm part 360 pivots about the second pivot pin 383a. Therefore, the distance between the lower protrusion 353 of the first arm part 350 and the lower protrusion 363 of the second arm part 360 increases or decreases as the first arm part 350 and the second arm part 360 pivot with respect to the first arm part 350.

When the auxiliary grip portion 310 is rotated around the fastening rod part 330 while the nut 340 threadedly engages with the threaded portion 331 of the fastening rod part 330, the fastening rod part 330 moves in the axial direction. Therefore, before the auxiliary handle member 300 is attached to the power tool 10, the auxiliary grip portion 310 is rotated in a first direction (e.g., counterclockwise) with respect to the fixing portion 320 to move the fastening rod part 330 in a direction in which the fastening rod part 330 protrudes from the auxiliary grip portion 310 to increase the distance between the larger diameter portion 332 of the fastening rod part 330 and the sleeve member 370. Thus, the first arm part 350 and the second arm part 360 are pivotable with respect to the bracket part 380 as shown in FIG. 14. At this time, a sufficient distance is formed between the lower protrusion 353 of the first arm part 350 and the lower protrusion 363 of the second arm part 360 so that the main body portion 20 of the power tool 10 is inserted between the first arm part 350 and the second arm part 360. The auxiliary handle member 300 is positioned with respect to the power tool 10 so that the first upper protrusion 384 and the second upper protrusion 385 of the bracket part 380 respectively engage the third recess 43 and the fourth recess 44 as shown in FIG. 14.

Next, the auxiliary grip portion 310 of the auxiliary handle member 300 is turned in a second direction (e.g., clockwise) with respect to the fixing portion 320 to move the fastening rod part 330 in a direction in which the fastening rod part 330 is retracted toward the auxiliary grip portion 310. As the fastening rod part 330 moves, the flange section 311 of the auxiliary grip portion 310 pushes the flange portion 371 of the sleeve member 370 so that the sleeve member 370 slides along the fastening rod part 330 toward the second arm part 360. Since the guide aperture 351a formed in the connecting wall section 350c of the first arm part 350 has the transverse width smaller than the outer diameter of the larger diameter portion 332 of the fastening rod part 330, the larger diameter portion 332 of the fastening rod part 330 presses against the connecting wall section 350c of the first arm part 350 towards the bracket part 380 as the fastening rod part 330 is rotated. Likewise, since the guide aperture 361a formed in the connecting wall section 360c of the second arm part 360 has the transverse width smaller than the outer diameter of the sleeve member 370, the distal end of the sleeve member 370 presses against the connecting wall section 360c of the second arm part 360 towards the bracket part 380 as the fastening rod part 330 is rotated. Therefore, the main body portion 20 of the power tool 10 is clamped between the first arm part 350 and the second arm part 360. This clamping force imparted on the main body portion 20 of the power tool 10 by the fixing portion 320 of the auxiliary handle member 300 further prevents the right housing cover 22 and the second housing cover 23 from separating from each other. At this time, the lower protrusion 353 of the first arm part 350 engages with the first recess 41 of the main body portion 20 and the lower protrusion 363 of the second arm part 360 engages with the second recess 42 of the main body portion 20. Moreover, as the lower protrusion 353, the lower protrusion 363 and the first and second upper protrusions 384 and 385 respectively engage with the first to fourth recesses 41 to 44, movement of the first and second arm parts 350 and 360 in the axial direction along the center axis C is restricted by the front end wall and the rear end wall of each of the first to fourth recesses 41 to 44. Therefore, both rotational movement and axial movement of the auxiliary handle member 300 relative to the main body portion 20 of the power tool 10 are prevented by engagement between the lower protrusion 353 and the first recess 41, between the lower protrusion 363 and the second recess 42, between the first upper protrusion 384 and the third recess 43, and between the second upper protrusion 385 and the fourth recess 44.

With the power tool assembly according to the third embodiment, the similar effects as the first and second embodiments can be obtained. More specifically, as shown in FIG. 15, the rear gear box 92, the sun gear 95 and the planetary gears 96 are disposed on a radial inner side of the first arm part 350 and the second arm part 360 of the fixing portion 320. Therefore, it is not necessary to provide an extra space in the front portion of the main body portion 20 to mount the auxiliary handle member 300. Accordingly, the overall longitudinal length of the main body portion 20 of the power tool 10 can be prevented from being increased.

Moreover, since the fixing portion 320 of the auxiliary handle member 300 according to the second embodiment is arranged to surround more than 180 degree of the circumference of the main body portion 20 when viewed along the longitudinal axis C of the main body portion 20 as shown in FIG. 15, rigid engagement between the fixing portion 320 and the main body portion 20 can be ensured, thereby preventing the auxiliary handle member 300 from accidentally slipping off or being misaligned with respect to the power tool 10 during operation of the power tool 10.

The first to third embodiments show an example in which the auxiliary handle member 100, 200 or 300 is positioned with respect to the power tool 10 so that the auxiliary grip portion 110, 210 or 310 is disposed on the left side of the main body portion 20 to generally form a right angle with respect to the grip portion 30 of the power tool 10 when viewed along the center axis C. However, it will be apparent to those skilled in the art from this disclosure that the auxiliary handle member 100, 200 or 300 can be positioned with respect to the power tool 10 so that the auxiliary grip portion 110, 210 or 310 is disposed on the right side of the main body portion 20 depending on the user's preference. In such a case, in the first embodiment, the lower protrusion 153 and the upper protrusion 154 of the first arm part 150 respectively engage with the second recess 42 and the fourth recess 44 of the main body portion 20, and the lower protrusion 163 and the upper protrusion 164 of the second arm part 160 respectively engage with the first recess 41 and the third recess 43 of the main body portion 20. In the second embodiment, the lower protrusion 253 and the upper protrusion 254 of the first arm part 250 respectively engage with the second recess 42 and the fourth recess 44 of the main body portion 20, and the lower protrusion 263 of the second arm part 260 engages with the first recess 41 of the main body portion 20. In the third embodiment, the first upper protrusion 384 and the second upper protrusion 385 of the bracket part 380 respectively engage with the fourth recess 44 and the third recess 43 of the main body portion 20, the lower protrusion 353 of the first arm part 350 engages with the second recess 42 of the main body portion 20, and the lower protrusion 363 of the second arm part 360 engages with the first recess 41 of the main body portion 20.

Furthermore, although the first to fourth recesses 41 to 44 are provided as the first to fourth engagement structures in the main body portion 20 of the power tool 10 and the protrusions 153, 154, 163 and 164, 253, 254, 163 and 264, or 353, 363, 384 and 385 are provided as the first to fourth engagement sections in the auxiliary handle member 100, 200 or 300 in the first to third embodiments, the engagement structures formed in the main body portion 20 of the power tool 10 and the engagement sections formed in the auxiliary handle member 100, 200 or 300 may be arranged such that the main body portion 20 includes protrusions and the auxiliary handle member 100, 200 or 300 includes recesses or openings that engage with the protrusions.

### Fourth Embodiment

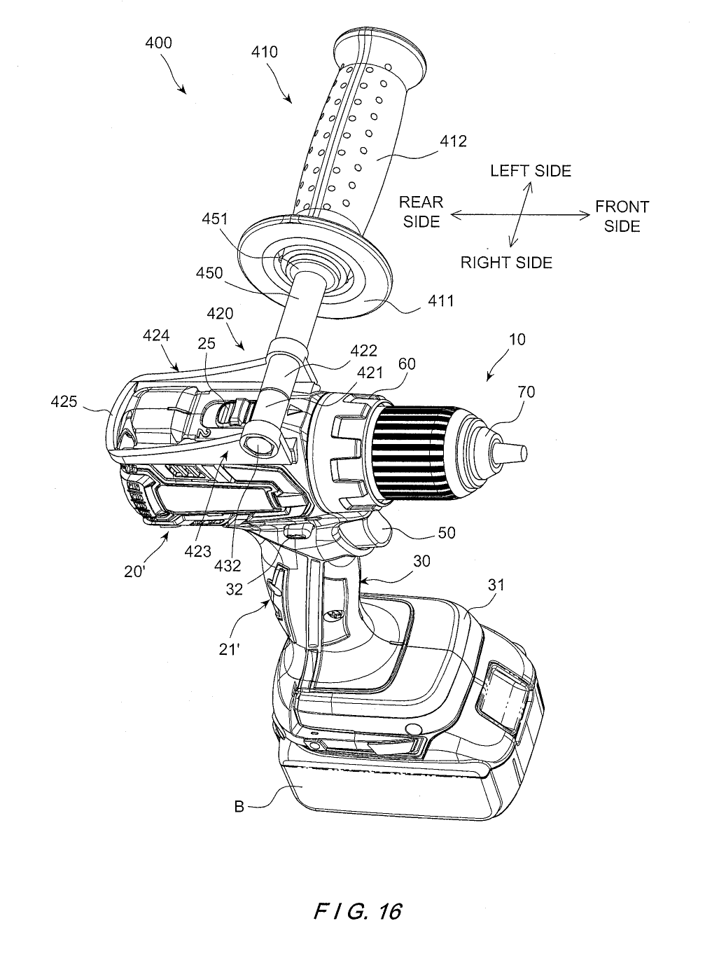

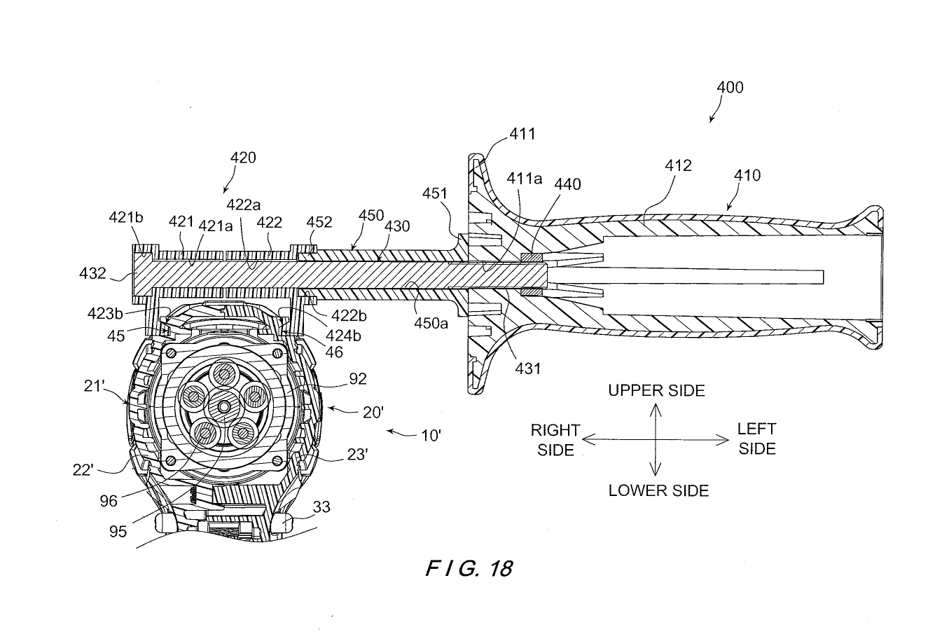

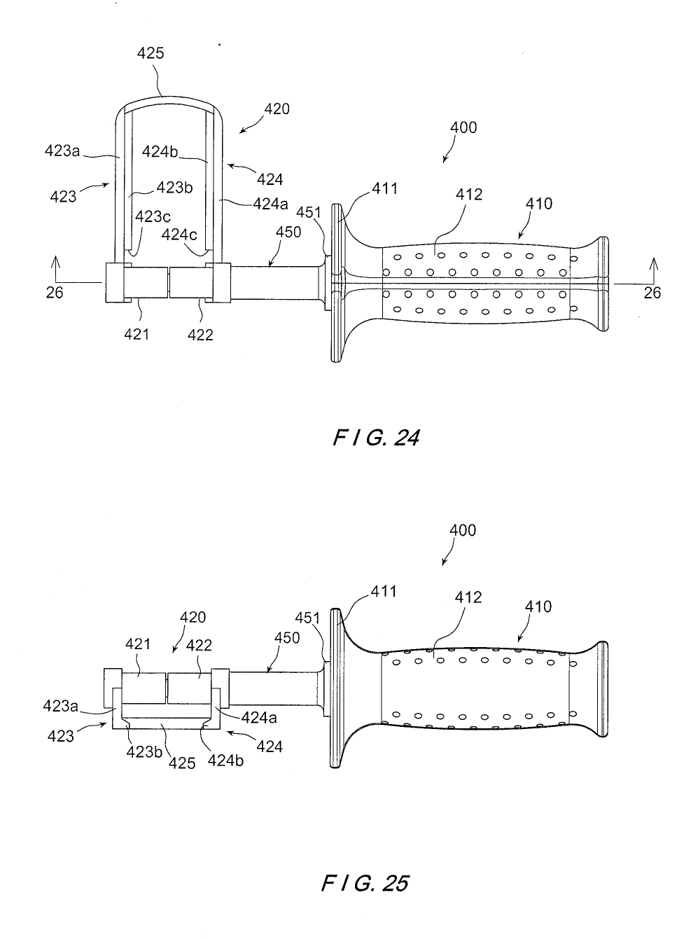

Referring now to FIGS. 16-26, a power tool assembly including the power tool 10′ and an auxiliary handle member 400 in accordance with a fourth embodiment will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity. The parts of the fourth embodiment that differ from the parts of the first embodiment will be indicated with a single prime (′).

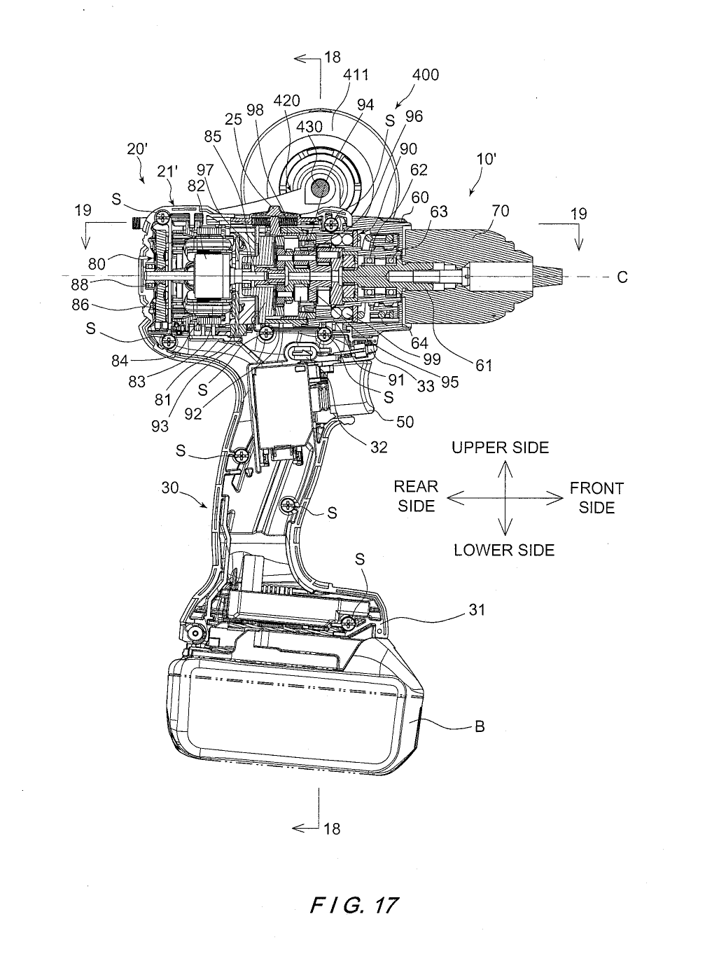

In the fourth embodiment, the power tool 10′ is a cordless driver drill. The power tool 10′ differs from the power tool 10 illustrated in the first embodiment except for the auxiliary handle member mounting structure provided in the power tool 10′. More specifically, as shown in FIGS. 16 to 21, the power tool 10′ has a generally pistol-like overall shape formed by a generally tubular main body portion 20′ and the grip portion 30. An outer surface of at least a part of the main body portion 20′ and the grip portion 30 are integrally formed to define an outer housing cover 21′. The outer housing cover 21′ is preferably made of resin material. More specifically, the outer housing cover 21′ includes a right housing cover 22′ (one example of a right side housing part) and a left housing cover 23′ (one example of a left side housing part). The right housing cover 22′ and the left housing cover 23′ are fixed together by a plurality of screws S (see, FIG. 17).

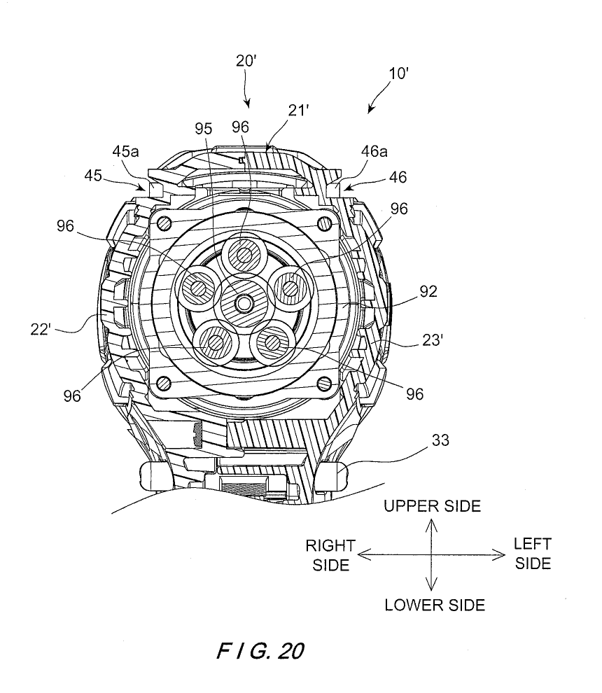

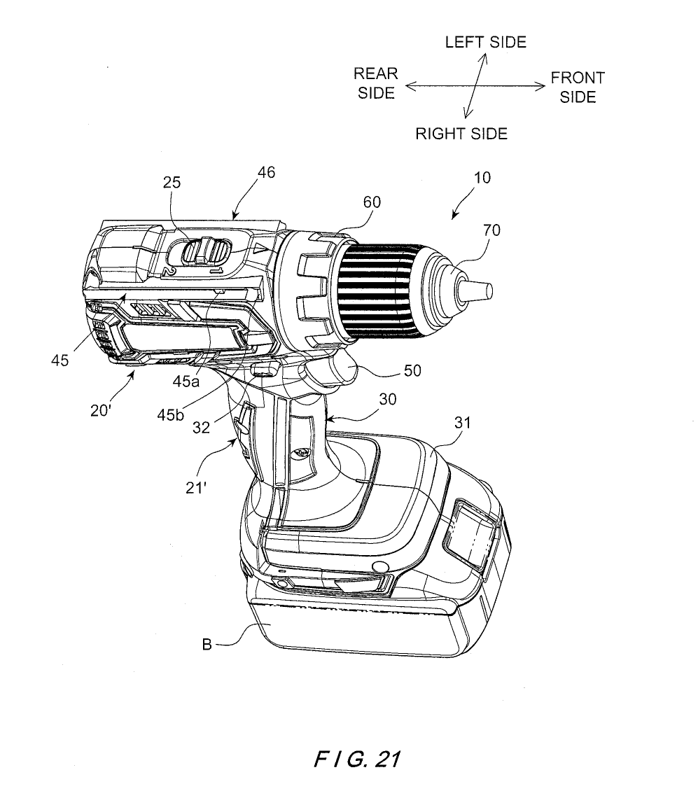

As shown in FIG. 21, the main body portion 20′ of the power tool 10′ is provided with a pair of first and second groove sections 45 and 46 extending parallel to each other in the longitudinal direction of the main body portion 20′. More specifically, as shown in FIGS. 20 and 21, the first groove section 45 is formed in the right housing cover 22′ in an upper region of the main body portion 20′ and the second groove section 46 is formed in the left housing cover 23′ in the upper region of the main body portion 20′. The first and second groove sections 45 and 46 correspond to the auxiliary handle mounting structures of this embodiment. As shown in FIG. 20, the first and second groove sections 45 and 46 are integrally formed in the outer housing cover 21′ (e.g., the respective one of the right housing cover 22′ and the left housing cover 23′) of the main body portion 20′. For example, when the outer housing cover 21′ of the power tool 10′ is made as a molded member, the first and second groove sections 45 and 46 can be formed (molded) simultaneously along with other portions of the outer housing cover 21′. Therefore, the first and second groove sections 45 and 46 can be formed on the power tool 10′ in a simple manner without additional parts.

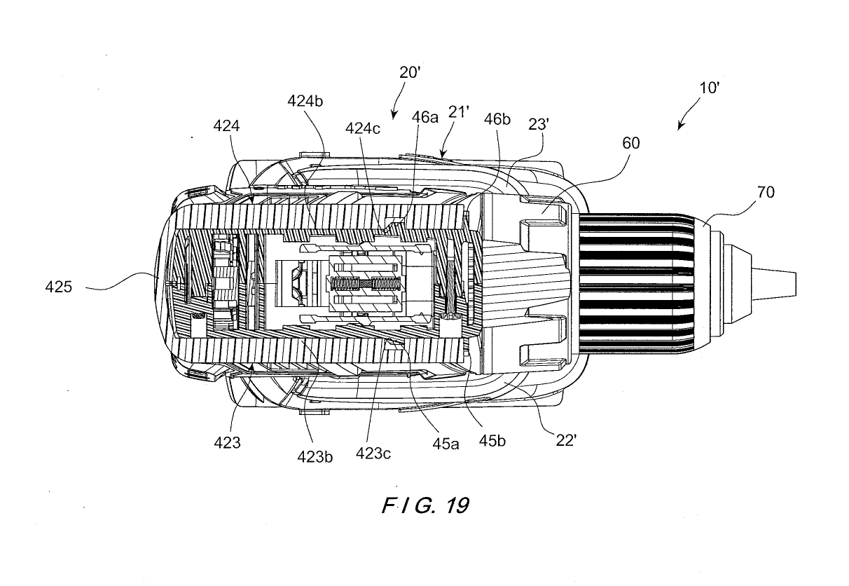

As shown in FIGS. 19 to 21, the first groove section 45 includes a projection 45a and a front end wall 45b. The projection 45a protrudes outwardly from a bottom surface of the first groove section 45. The front end wall 45b is disposed at a front end of the first groove section 45. Although only the projection 45a and the front end wall 45b of the first groove section 45 are illustrated in FIG. 21, the structure of the second groove section 46 is basically the same as the first groove section 45 except that the second groove section 46 is a mirror image of the first groove section 45. In other words, as shown in FIGS. 19 and 20, the second groove section 46 includes a projection 46a and a front end wall 46b.

As shown in FIG. 17, the power tool 10′ includes the speed change lever 25, the trigger-type switch lever 50, the rotational direction change lever 32, the light unit 33, the tubular change-ring 60, the spindle 61, the power tool chuck 70, the motor unit 80, and the gear assembly 90. Since the components of the power tool 10′, such as the tubular change ring 60, the power tool chuck 70, the motor unit 80 and the gear assembly 90, are conventional components that are well known in the art, the structure of these components will not be discussed or illustrated in detail herein. Rather, it will be apparent to those skilled in the art from this disclosure that the components of the power tool 10′ can have any type of suitable structure.

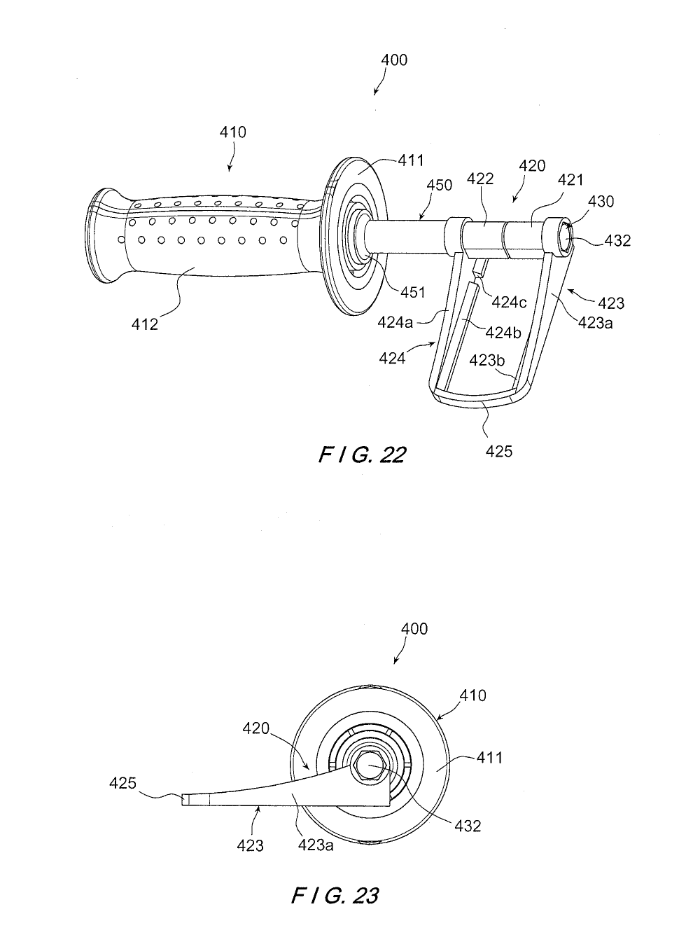

Referring now to FIGS. 22 to 26, the structure of the auxiliary handle member 400 will now be described. The auxiliary handle member 400 is an auxiliary tool that is removably coupled to the power tool 10′ to provide a secondary grip portion for a user to support the power tool 10′ with both hands during operation. The auxiliary handle member 400 basically includes an auxiliary grip portion 410 and a fixing portion 420. The fixing portion 420 is rotatably coupled to the auxiliary grip portion 410 by a fastening rod part 430 and a nut 440. The fixing portion 420 is configured and arranged to be fixed to the main body portion 20′ of the power tool 10′ as described in more detail below. The auxiliary handle member 400 further includes a sleeve member 450 disposed between the auxiliary grip portion 410 and the fixing portion 420.

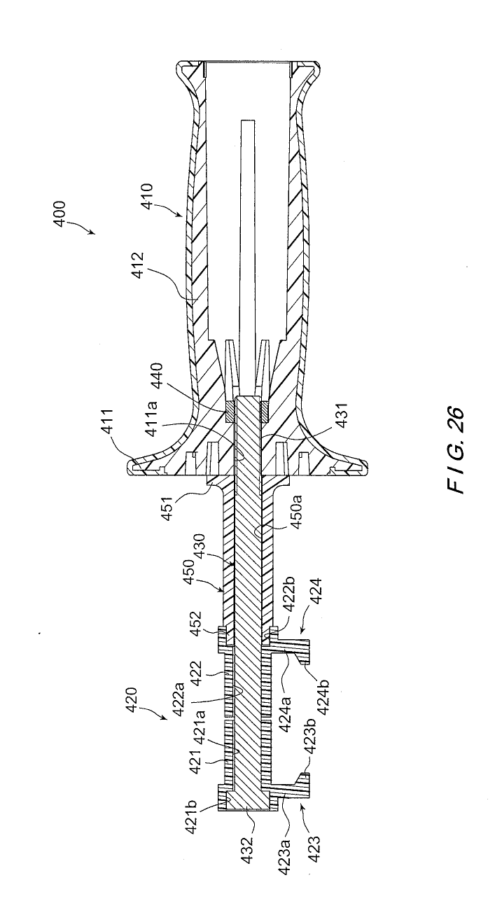

The auxiliary grip portion 410 of the auxiliary handle member 400 includes a flange section 411 and a body section 412. As shown in FIG. 26, a through-hole 411a is formed in the flange section 411 for passing the fastening rod part 430. The nut 440 engages with a threaded portion 431 formed in a proximate end of the fastening rod part 430 to fix the fastening rod part 430 to an inner end part of the through-hole 411a. An outer surface of the body section 412 is preferably made of rubber or plastic material, and may be provided with an anti-slip surface structure or coating to prevent the user's hand from slipping during operation.

As shown in FIGS. 22 to 26, the fixing portion 420 includes a first base section 421, a second base section 422, a first fixing section 423, a second fixing section 424 and a bridge section 425. The first base section 421, the second base section 422, the first fixing section 423, the second fixing section 424 and the bridge section 425 of the fixing portion 420 are preferably formed integrally, and made of material that allows slight elastic deformation, such as resin material. The first base section 421 is a generally cylindrical member having a first through hole 421a, and the second base section 422 is a generally cylindrical member having a second through hole 422a. The first base section 421 and the second base section 422 are coaxially aligned so that the fastening rod part 430 passes through the first through hole 421a and the second through hole 422a. A counterbore 421b is provided at an axial end of the first through hole 421a opposite from the second base section 422. A larger diameter portion 432 formed at a distal end of the fastening rod part 430 is fitted in the counterbore 421b so as to prevent the fastening rod part 430 from separating from the fixing portion 420. A counterbore 422b is provided at an axial end of the second through hole 422a opposite from the first base section 421 so that a smaller diameter portion 452 formed at a distal end of the sleeve member 450 is fitted in the counterbore 422b.

The first fixing section 423 and the second fixing section 424 extend parallel to each other from the first base section 421 and the second base section 422, respectively. The first fixing section 423 includes a first side wall 423a and a first lip section 423b protruding inwardly from the first side wall 423a. The second fixing section 424 includes a second side wall 424a and a second lip section 424b protruding inwardly from the second side wall 424a. The first lip section 423b and the second lip section 424b are arranged to be slidably coupled to the first groove section 45 and the second groove section 46 formed in the main body portion 20′ of the power tool 10′ when the auxiliary handle member 400 is coupled to the power tool 10′. A notch 423c is provided in the first lip section 423b at a position corresponding to the projection 45a of the first groove section 45 when the auxiliary handle member 400 is coupled to the power tool 10′. Similarly, a notch 424c is provided in the first lip section 424b at a position corresponding to the projection 46a of the second groove section 46 when the auxiliary handle member 400 is coupled to the power tool 10′. As shown in FIG. 19, the projection 45a of the first groove section 45 and the projection 46a of the second groove section 46 are fitted in the notch 423c of the first lip section 423b and the notch 424c of the second lip section 424b, respectively, to restrict a relative movement between the main body portion 20′ of the power tool 10′ and the auxiliary handle member 400 in the longitudinal direction of the main body portion 20′. As shown in FIGS. 22 to 25, the bridge section 425 extends between distal ends of the first fixing section 423 and the second fixing section 424.

The sleeve member 450 is a generally cylindrical member having a through hole 450a through which the fastening rod part 430 slidably passes. The sleeve member 450 includes a flange portion 451 that abuts against the flange section 411 of the auxiliary grip portion 410. The distal end of the sleeve member 450 includes the smaller diameter portion 452 that is fitted in the counterbore 422b of the second base section 422.

When the auxiliary grip portion 410 is rotated around the fastening rod part 430 while the nut 440 threadedly engages with the threaded portion 431 of the fastening rod part 430, the fastening rod part 430 moves in the axial direction. Therefore, the distance between the auxiliary grip portion 410 and the larger diameter portion 432 formed at the distal end of the fastening rod part 430 increases or decreases as the auxiliary grip portion 410 is rotated with respect to the fixing portion 420.

Therefore, before the auxiliary handle member 400 is attached to the power tool 10′, the auxiliary grip portion 410 is rotated in a first direction (e.g., counterclockwise) with respect to the fixing portion 420 to move the fastening rod part 430 in a direction in which the fastening rod part 430 protrudes from the auxiliary grip portion 410. At this time, a sufficient distance is formed between the larger diameter portion 432 of the fastening rod part 430 and the auxiliary grip portion 410 so as to allow slight elastic deformation of the fixing portion 420 in a direction in which the first base section 421 and the second base section 422 separate from each other. In this state, the first lip section 423b and the second lip section 424b of the fixing portion 420 of the auxiliary handle member 400 are slidably inserted in the first groove section 45 and the second groove section 46, respectively, from the rear ends of the first groove section 45 and the second groove section 46. At this time, since slight elastic deformation of the fixing portion 420 is allowed in the direction in which the first base section 421 and the second base section 422 separate from each other, front portions of the first lip section 423b and the second lip section 424b ride over the projection 45a formed in the first groove section 45 and the projection 46a formed in the second groove section 46 as they slide in the first groove section 45 and the second groove section 46, respectively. The projection 45a formed in the first groove section 45 and the projection 46a formed in the second groove section 46 are fitted in the notch 423c formed in the first lip section 423b and the notch 424c formed in the second lip section 424b, respectively, so as to restrict the relative movement between the fixing portion 420 and the main body portion 20′ in the longitudinal direction of the main body portion 20′. The engagement between the projection 45a formed in the first groove section 45 and the notch 423c and the engagement between the projection 46a formed in the second groove section 46 and the notch 424c ensure proper positioning between the fixing portion 420 and the main body portion 20′ in the longitudinal direction of the main body portion 20′. Moreover, as shown in FIG. 19, the front ends of the first lip section 423b and the second lip section 424b abut against the front end wall 45b of the first groove section 45 and the front end wall 46b of the second groove section 46, respectively, to restrict further longitudinal movement of the fixing portion 420 toward the front direction with respect to the main body portion 20′. Thus, the front end wall 45b of the first groove section 45 and the front end wall 46b of the second groove section 46 also ensure proper positioning of the fixing portion 420 with respect to the main body portion 20′ in the longitudinal direction.

Next, the auxiliary grip portion 410 of the auxiliary handle member 400 is turned in a second direction (e.g., clockwise) with respect to the fixing portion 420 to move the fastening rod part 430 in a direction in which the fastening rod part 430 is retracted toward the auxiliary grip portion 410. As the fastening rod part 430 is retracted toward the auxiliary grip portion 410, the flange section 411 of the auxiliary grip portion 410 pushes the flange portion 451 of the sleeve member 450 so that the sleeve member 450 slides along the fastening rod part 430 toward the fixing portion 420. As the fastening rod part 430 keeps moving, the smaller diameter portion 452 of the sleeve member 450 pushes the second base section 422 toward the first base section 421, and the larger diameter portion 432 of the fastening rod part 430 pushes the first base section 421 toward the second base section 422. Therefore, the main body portion 20′ of the power tool 10′ is tightly clamped between the first fixing section 423 and the second fixing section 424. In such a state, the elastic deformation of the fixing portion 420 is restricted to prevent the first lip section 423b and the second lip section 424b from riding over the projection 45a formed in the first groove section 45 and the projection 46a formed in the second groove section 46. Accordingly, both longitudinal movement and vertical movement of the auxiliary handle member 400 relative to the main body portion 20′ of the power tool 10′ are prevented.

With the power tool assembly according to the fourth embodiment, positions of the projection 45a formed in the first groove section 45 and the projection 46a formed in the second groove section 46, and positions of the notch 423c and the notch 424c are set so that, when the auxiliary handle member 400 is fixed to the power tool 10′, the grip portion 30 of the power tool 10′ and the auxiliary grip portion 410 of the auxiliary handle member 400 are generally aligned along the circumferential direction of the main body portion 20′ as shown in FIG. 16. With this arrangement, it is easier to gain sufficient leverage to properly operate the power tool by holding the power tool 10′ by two grip portions that are disposed at generally equal distance from the work piece. Moreover, with the power tool 10′ according to the first embodiment, it is not necessary to provide an extra space in the front portion of the main body portion 20′ for forming the auxiliary handle mounting structure (e.g., the first groove section 45 and the second groove section 46). In other words, the existing space on the main body portion 20′ can be efficiently used to form the auxiliary handle mounting structure. Therefore, the overall longitudinal length of the main body portion 20′ of the power tool 10′ can be prevented from being increased. Thus, the usability of the power tool 10′ with the auxiliary handle member 400 is improved even in a confined working space. Moreover, since the auxiliary handle member 400 is attached at generally the same axial position as the grip portion 30, the auxiliary handle member 400 is prevented from interfering with a target workpiece even when the target workpiece has a shape that bulges out towards the power tool 10′.

Although the power tool 10′ is illustrated as a driver drill in the fourth embodiment, the power tool assembly according to the first embodiment is applicable to various types of power tools, such as a hammer driver drill, an impact driver, an impact wrench, etc.

FIGS. 16 to 19 show an example in which the auxiliary handle member 400 is positioned with respect to the power tool 10′ so that the auxiliary grip portion 410 is disposed on the left side of the main body portion 20′ to generally form a right angle with respect to the grip portion 30 of the power tool 10′ when viewed along the center axis C. However, it will be apparent to those skilled in the art from this disclosure that the auxiliary handle member 400 can be positioned with respect to the power tool 10′ so that the auxiliary grip portion 410 is disposed on the right side of the main body portion 20′ depending on the user's preference. In such a case, the auxiliary grip portion 410, the sleeve member 450 and the fixing portion 420 are first disassembled by releasing threaded engagement between the nut 440 and the fastening rod part 430, and then reassembled together so that the sleeve member 450 is disposed on a side of the first base section 421 between the auxiliary grip portion 410 and the fixing portion 420.

Furthermore, although the first groove section 45 and the second groove section 46 are provided as the engagement structures in the main body portion 20′ of the power tool 10′ and the first lip section 423b and the second lip section 424b are provided as the engagement sections in the auxiliary handle member 400 in the fourth embodiment, the engagement structures formed in the main body portion 20′ of the power tool 10′ and the engagement sections formed in the auxiliary handle member 400 may be arranged such that the main body portion 20′ includes lip sections and the auxiliary handle member 400 includes groove sections that engage with the lip sections.

In the first to fourth embodiments, the auxiliary handle member 100, 200, 300 or 400 is configured such that the entire auxiliary grip portion 110, 210, 310 or 410 rotates with respect to the fixing portion 120, 220, 320 or 420 to tighten the fixing portion 120, 220, 320 or 420 onto the auxiliary handle mounting structure of the power tool 10 or 10′. However, the flange section 111, 211, 311 or 411 and the body section 112, 212, 312 or 412 of the auxiliary grip portion 110, 210, 310 or 410 may be formed as separate members so that only the flange section 111, 211, 311 or 411 is rotated with respect to the fixing portion 120, 220, 320 or 420. Moreover, the auxiliary handle member 100, 200, 300 or 400 may be provided with an additional attachment part such as a depth gage and the like.

Although the power tool 10 or 10′ is illustrated as a driver drill in the first to fourth embodiments, the power tool assembly according to the first to fourth embodiments is applicable to various types of power tools, such as a hammer driver drill, an impact driver, an impact wrench, etc.

Although the cordless power tool 10 or 10′ is illustrated as an example of a power tool in the first to fourth embodiments, the power tool is not limited to a cordless tool coupled to a rechargeable battery. It will be apparent to those skilled in the art from this disclosure that the power tool assembly according to any of the first to fourth embodiments is applicable to a corded power tool with a power cable.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “front”, “rear”, “above”, “downward”, “vertical”, “horizontal”, “below” and “transverse” as well as any other similar directional terms refer to those directions of a power tool when the power tool is oriented as shown in FIG. 2. Accordingly, these terms, as utilized to describe the present invention should be interpreted relative to the power tool. The terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A power tool assembly comprising:
a power tool including
a motor unit,
a generally tubular main body portion accommodating the motor unit therein, an outer surface of the main body portion including a first engagement structure disposed on a first side of the main body portion and a second engagement structure disposed on a second side of the main body portion, and
a grip portion extending from the main body portion,
an auxiliary handle member including
an auxiliary grip portion, and
a fixing portion fixed to the main body portion of the power tool for fixedly coupling the auxiliary grip portion to the main body portion with the fixing portion surrounding more than 180 degree of a circumference of the main body portion when viewed along a longitudinal axis of the main body portion, the fixing portion including a first arm part with a first engagement section engaging with the first engagement structure and a second arm part with a second engagement section engaging with the second engagement structure, the first arm part and the second arm part being movable relative to each other to change a distance between the first engagement section and the second engagement section before the fixing portion is fixed to the main body portion of the power tool.

2. The power tool assembly according to claim 1, wherein
each of the first and second engagement structures of the main body portion of the power tool includes a recess integrally formed in an outer housing cover of the main body portion, and
each of the first and second engagement sections of the first and second arm parts of the auxiliary handle member includes a protrusion.

3. The power tool assembly according to claim 1, wherein
the second arm part is movable with respect to the first arm part along a linear path.

4. The power tool assembly according to claim 3, wherein
the auxiliary handle member further includes a fastening rod part coupling the auxiliary grip portion to the first arm part and the second arm part, and
the second arm part is movable with respect to the first arm part along a longitudinal axis of the fastening rod part.

5. The power tool assembly according to claim 1, wherein
the second arm part is movable with respect to the first arm part along an arcuate path.

6. The power tool assembly according to claim 5, wherein
the second arm part is pivotable with respect to the first arm part.

7. The power tool assembly according to claim 1, wherein
the first arm part and the second arm part are movable along arcuate paths.

8. The power tool assembly according to claim 7, wherein
the auxiliary handle member further includes
a bracket part disposed between the first arm part and the second arm part, and
a fastening rod part fixedly coupling the grip portion to the first arm part, the bracket part and the second arm part,
the first arm part and the second arm part being pivotable with respect to the bracket part.

9. The power tool assembly according to claim 8, wherein
the main body portion of the power tool further includes a third engagement structure spaced apart from the first and second engagement structures in a circumferential direction of the main body portion, and
the bracket part of the auxiliary handle member includes a third engagement section that engages with the third engagement structure of the main body portion.

10. The power tool assembly according to claim 9, wherein
the main body portion of the power tool further includes a fourth engagement structure spaced apart from the first, second and third engagement structures in a circumferential direction of the main body portion, and
the bracket part of the auxiliary handle member further includes a fourth engagement section that engages with the fourth engagement structure of the main body portion.

11. The power tool assembly according to claim 1, wherein
the main body portion of the power tool further includes a third engagement structure spaced apart from the first and second engagement structures in a circumferential direction of the main body portion, and
one of the first and second arm parts includes a third engagement section engaging with the third engagement structure.

12. The power tool assembly according to claim 11, wherein
the main body portion of the power tool further includes a fourth engagement structure spaced apart from the first, second and third engagement structures in a circumferential direction of the main body portion, and
the other of the first and second arm parts includes a fourth engagement section engaging with the fourth engagement structure.

13. An auxiliary handle member adapted to be coupled to a generally cylindrical main body portion of a power tool including a first engagement structure disposed on a first side of an outer surface of the main body portion and a second engagement structure disposed on a second side of the outer surface of the main body portion, the auxiliary handle member comprising:
an auxiliary grip portion; and
a fixing portion coupled to the grip portion, and configured and arranged to be fixedly coupled to the main body portion of the power tool with the fixing portion surrounding more than 180 degree of a circumference of the main body portion when viewed along a longitudinal axis of the main body portion, the fixing portion including
a first arm part with a first engagement section configured and arranged to engage with the first engagement structure, and
a second arm part with a second engagement section configured and arranged to engage with the second engagement structure,
the first arm part and the second arm part being movable relative to each other to change a distance between the first engagement section and the second engagement section.

14. The auxiliary handle member according to claim 13, wherein
each of the first and second engagement sections of the first and second arm parts includes a protrusion.

15. The auxiliary handle member according to claim 13, wherein
the second arm part is movable with respect to the first arm part along a linear path.

16. The auxiliary handle member according to claim 15, further comprising
a fastening rod part configured and arranged to fixedly couple the auxiliary grip portion to the first arm part and the second arm part, and
the second arm part is movable with respect to the first arm part along a longitudinal axis of the fastening rod part.

17. The auxiliary handle member according to claim 13, wherein
the second arm part is movable with respect to the first arm part along an arcuate path.

18. The auxiliary handle member according to claim 17, wherein
the second arm part is pivotable with respect to the first arm part.

19. The auxiliary handle member according to claim 13, wherein
the first arm part and the second arm part are movable along arcuate paths.

20. The auxiliary handle member according to claim 19, further comprising
a bracket part disposed between the first arm part and the second arm part, and
a fastening rod part configured and arranged to fixedly couple the auxiliary grip portion to the first arm part, the bracket part and the second arm part,
the first arm part and the second arm part being pivotable with respect to the bracket part.

21. A power tool comprising:
a motor unit;
a generally tubular main body portion accommodating the motor unit therein, an outer surface of the main body portion including a pair of auxiliary handle mounting structures extending along a longitudinal direction of the main body portion so as to slidably engage with an auxiliary handle member along the longitudinal direction; and
a grip portion extending from the main body portion.

22. The power tool according to claim 21, further comprising
the auxiliary handle member including an auxiliary grip portion and a fixing portion including a pair of engaging sections slidably engaging the auxiliary handle mounting structures of the main body portion of the power tool.

23. The power tool according to claim 22, wherein
each of the auxiliary handle mounting structures includes one of a groove section and a lip section extending in the longitudinal direction of the main body portion, and
each of the engaging sections of the fixing portion of the auxiliary handle member includes the other of the groove section and the lip section slidably engaging the one of the groove section and the lip section of each of the auxiliary handle mounting structures.

24. The power tool according to claim 23, wherein
each of the auxiliary handle mounting structures includes the groove section, and
each of the engaging sections of the fixing portions includes the lip section.

25. The power tool according to claim 23, wherein
the groove section includes a projection, and
the lip section includes a notch engaging with the projection to restrict a relative movement between the main body portion and the auxiliary handle member in the longitudinal direction of the main body portion.

26. The power tool according to claim 24, wherein
each of the auxiliary handle mounting structures includes a front end wall disposed at a front end of the groove section so that a front end surface of the lip section of each of the engaging sections abuts against the front end wall.

27. A power tool assembly comprising:
a power tool including
a motor unit, and
a resin housing member accommodating the motor unit therein; and
an auxiliary handle member including
a first arm part fixed to the resin housing member, and
a second arm part fixed to the resin housing member.

28. The power tool assembly according to claim 27, wherein
the resin housing member includes a right side housing part and a left side housing part with the right side housing part and the left side housing part being coupled together by a screw member,
the first arm part and the second arm part of the auxiliary handle member are disposed in rear of the screw member with respect to a longitudinal direction of the power tool.

29. A power tool assembly comprising:
a power tool including
a motor unit, and
a housing member accommodating the motor unit therein; and
an auxiliary handle member including
a first arm part fixed to the housing member, and
a second arm part fixed to the housing member,
the first arm part being pivotable with respect to the second arm part.

30. A power tool assembly comprising:
a power tool including
a motor unit, and
a housing accommodating the motor unit therein, the housing including at least three recesses; and
an auxiliary handle member fixed to the housing of the power tool with the auxiliary handle member engaging with the recesses formed in the housing.
